(19) United States
(12) Patent Application Publication
(10) Pub. No.: US 2026/0236214 A1
(43) Pub. Date: Aug. 13, 2026

(54) SYSTEM, METHOD, AND PROGRAM

(71) Applicant: Sony Group Corporation, Tokyo (JP)

(72) Inventors: Takanori KUBOTA, Tokyo (JP); Teruyuki USHIRO, Tokyo (JP); Hidenari SHINOTO, Tokyo (JP); Kosuke MORI, Tokyo (JP); Kota NAKAMURA, Tokyo (JP); Ryosuke SAITO, Tokyo (JP); Kyomin SASAKI, Tokyo (JP); Yuma HIRAI, Tokyo (JP); Norifumi KIKKAWA, Tokyo (JP); Kenta ABE, Tokyo (JP)

(73) Assignee: Sony Group Corporation, Tokyo (JP)

(21) Appl. No.: 19/158,061

(22) PCT Filed: Jan. 12, 2024
(86) PCT No.: PCT/JP2024/000700

§ 371 Date: Aug. 20, 2025

(30) Foreign Application Priority Data
Mar. 14, 2023 (JP) 2023-040043

(51) Int. Cl. G06F 3/16; G06T 19/20

(52) U.S. Cl. CPC G06F 3/165; G06T 19/20; G06T 2219/2004

(57) ABSTRACT

Provided is a system including a control unit that controls client terminals used to operate avatars in a virtual space and controls information synchronization in a cluster containing a plurality of the client terminals. The control unit creates an environmental sound by combining sounds in the virtual space. The control unit creates an individual environmental sound by removing sound components of the avatars from the environmental sound. The control unit outputs the individual environmental sounds from the client terminals corresponding to the avatars at the time of output of the environmental sounds from the client terminals.

### TECHNICAL FIELD

The present disclosure relates to a system, a method, and a program.

### BACKGROUND ART

There are various types of services of what are generally called metaverses each provided to enable a user to operate an avatar corresponding to another self of the user and interact with different users in an virtual space. The user can do his or her shopping in a town, see a live performance in a concert venue, or play soccer in a stadium all reproduced in the virtual space.

### CITATION LIST

### Patent Literature

### [NPL 1]

“Exhibited in docomo Open House '23: development of communication activation technology achieved by simultaneous connection between enormous number of persons, value understanding, and behavior change—metacommunication realized by integrated network and service—<Feb. 1, 2023>,” URL: https://www.docomo.ne.jp/info/news release/2023/02/01_00. html, <searched Mar. 13, 2023>

### SUMMARY

### Technical Problem

There are demands for further improvement in usability of such a type of virtual space.

The present disclosure proposes a system, a method, and a program capable of improving usability of a virtual space.

### Solution to Problem

Provided according to the present disclosure is a system including a control unit that controls client terminals used to operate avatars in a virtual space and controls information synchronization in a cluster containing a plurality of the client terminals. A plurality of the clusters are present. The control unit arranges virtual avatars in the virtual space. The control unit creates sounds of the virtual avatars in accordance with a type of an event held in the virtual space. The control unit performs a stereoscopic process in accordance with positions of respective different avatars and the respective virtual avatars for sounds output from the client terminals and emitted from the different avatars and the virtual avatars.

Further provided according to the present disclosure is a system including a control unit that controls client terminals used to operate avatars in a virtual space and controls information synchronization in a cluster containing a plurality of the client terminals. The control unit creates an environmental sound by combining sounds in the virtual space. The control unit creates an individual environmental sound by removing sound components of the avatars from the environmental sound. The control unit outputs the individual environmental sounds from the client terminals corresponding to the avatars at a time of output of the environmental sounds from the client terminals.

Further provided according to the present disclosure is a method performed by a processor, the method including controlling client terminals used to operate avatars in a virtual space and controlling information synchronization in a cluster containing a plurality of the client terminals, creating an environmental sound by combining sounds in the virtual space, creating an individual environmental sound by removing sound components of the avatars from the environmental sound, and outputting the individual environmental sounds from the client terminals corresponding to the avatars at a time of output of the environmental sounds from the client terminals.

Further provided according to the present disclosure is a program causing a computer to function as a control unit that controls client terminals used to operate avatars in a virtual space and controls information synchronization in a cluster containing a plurality of the client terminals. The control unit creates an environmental sound by combining sounds in the virtual space. The control unit creates an individual environmental sound by removing sound components of the avatars from the environmental sound. The control unit outputs the individual environmental sounds from the client terminals corresponding to the avatars at a time of output of the environmental sounds from the client terminals.

### BRIEF DESCRIPTION OF DRAWINGS

FIG. 1 is a diagram illustrating an example of an SFU system.

FIG. 2 is a diagram illustrating an example of a layered structure applied to a network system according to an embodiment of the present technology.

FIG. 3 is a diagram illustrating an example of data transmission and reception.

FIG. 4 is a diagram illustrating a configuration example of a network system according to an embodiment of the present technology.

FIG. 5 is a diagram illustrating an example of data transmission and reception.

FIG. 6 is a diagram illustrating an example of a metaverse virtual space.

FIG. 7 is a diagram illustrating an example of data transmission and reception.

FIG. 8 is a diagram illustrating a configuration example of a network.

FIG. 9 is a diagram illustrating an example of movement of players.

FIG. 10 is a diagram illustrating an example of a variable configuration of the network.

FIG. 11 is a diagram illustrating a configuration example of a network system performing dynamic control of the network configuration.

FIG. 12 is a flowchart explaining a process performed by the network system.

FIG. 13 is a diagram illustrating an example of the network configuration.

FIG. 14 is a diagram illustrating an example of the network configuration.

FIG. 15 is a diagram illustrating an example of the network configuration.

FIG. 16 is a diagram illustrating an example of arrangement of avatars.

FIG. 17 is a diagram illustrating a configuration example of a network system performing sound output control.

FIG. 18 is a flowchart explaining a process performed by the network system.

FIG. 19 is a block diagram illustrating a configuration example of the network system.

FIG. 20 is a block diagram illustrating a configuration example of a computer.

FIG. 21 is a diagram illustrating an example of a configuration of a volume control system according to an embodiment of the present disclosure.

FIG. 22 is a diagram explaining volume control of a sound emitted from a different avatar 500b in accordance with a distance between a user avatar 500a and the different avatar 500b.

FIG. 23 is a diagram for explaining a comparative example of volume control at the time of a large position change in a short period.

FIG. 24 is a block diagram illustrating an example of a configuration of a server 30 according to the present embodiment.

FIG. 25 is a diagram for explaining volume control performed in accordance with a predicted position change.

FIG. 26 is a flowchart illustrating an example of a flow of volume control according to the present embodiment.

FIG. 27 is a diagram for explaining correction of deviation of position information reception timing.

FIG. 28 is a diagram illustrating an example of a change of an avatar display mode for clearly indicating low quality of a communication environment.

FIG. 29 is a diagram for explaining a case where a conversation voice is contained in an environmental sound and heard as a double sound.

FIG. 30 is a diagram for explaining an outline of an environmental sound providing system according to the present embodiment.

FIG. 31 is a diagram illustrating an example of a configuration of an environmental sound providing system according to an embodiment of the present disclosure.

FIG. 32 is a block diagram illustrating an example of a configuration of a server 60 according to the present embodiment.

FIG. 33 is a diagram explaining details of provision of environmental sounds.

FIG. 34 is a diagram for explaining details of a group environmental sound creation unit 6221.

FIG. 35 is a flowchart illustrating an example of an operation process performed by the environmental sound providing system according to the present embodiment.

FIG. 36 is a diagram for explaining a case where individual environmental sounds are created by client terminals 212.

FIG. 37 is a diagram explaining creation of an environmental sound for each cluster according to modification 1.

FIG. 38 is a diagram explaining details of creation of environmental sounds according to modification 1.

FIG. 39 is a diagram explaining creation of individual environmental sounds by an individual environmental sound creation unit 622A.

FIG. 40 is a diagram explaining details of creation of environmental sounds according to modification 2.

FIG. 41 is a diagram explaining creation of individual environmental sounds by an individual environmental sound creation unit 622B.

FIG. 42 is a diagram for explaining creation of environmental sounds according to modification 3.

FIG. 43 is a diagram for explaining creation of environmental sounds according to modification 4.

FIG. 44 is a diagram for explaining details of creation of environmental sounds according to modification 4.

FIG. 45 is a diagram for explaining details of a venue environmental sound creation unit 6214.

FIG. 46 is a diagram for explaining details of creation of individual environmental sounds by an individual environmental sound creation unit 622C.

### DESCRIPTION OF EMBODIMENTS

Modes for carrying out the present technology will hereinafter be described. The description will be presented in the following order.
1. Technology for scaling out number of persons simultaneously connected to metaverse virtual space
2. Low-delay synchronization communication technology based on behavior prediction in metaverse virtual space
3. Sound transmission effect control technology based on distance and structure in metaverse virtual space
4. System configuration
5. Others
6. Volume control technology according to sound source position change in virtual space
7. Environmental sound creation technology in virtual space
8. Additional notes

### 1. Technology for Scaling Out Number of Persons Simultaneously Connected to Metaverse Virtual Space

A user using a service in a virtual space what is generally called a “metaverse” operates a terminal corresponding to a client, and accesses a server to use the service. Such a device as a smartphone, a PC, and an HMD (VR glasses) is available as the client.

Various types of information such as a sound, video, position information associated with an avatar in a virtual space, and behavior information associated with an avatar are transmitted and received between the client operated by the user and a server on the Internet. An SFU (Selective Forwarding Unit) system is one of systems for transmitting and receiving information via a server. Chiefly discussed hereinafter will be a case where information transmitted and received between devices is position information. However, other types of information are also transmitted and received in similar manners.

A metaverse is a service provided in a virtual space and used for establishing communication between a user and a different user by using an avatar operated by the user as another self. A metaverse virtual space is a virtual space used for providing services in the metaverse.

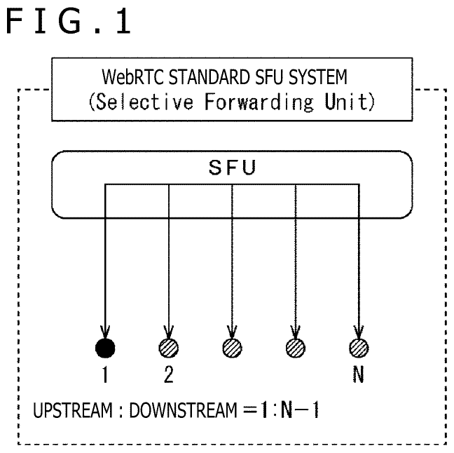

FIG. 1 is a diagram illustrating an example of the SFU system.

Each of small circles illustrated in FIG. 1 corresponds to a participation node (client). Data transmitted by a certain participation node is transferred to all of the other participation nodes via an SFU. When the number of participation nodes is N, a total amount of downstream traffic is expressed as N(N−1).

Assuming that a transfer rate per one sound stream is 16 Kbps, the following downstream communication speed is required.
When N=50, downstream communication speed=16 K×N(N−1)=39 Mbps
When N=1,000, downstream communication speed=16 K×N(N−1)=16 Gbps
When N=10,000, downstream communication speed=16 K×N(N−1)=1.6 Tbps

In general, an upper limit number of participation nodes for the SFU system is approximately 50. According to a cloud service such as AWS (Amazon Web Services) (trademark), a pay-per-use system is typically applied to downstream traffic. Accordingly, service operation costs increase in proportion to the square of the number of participants.

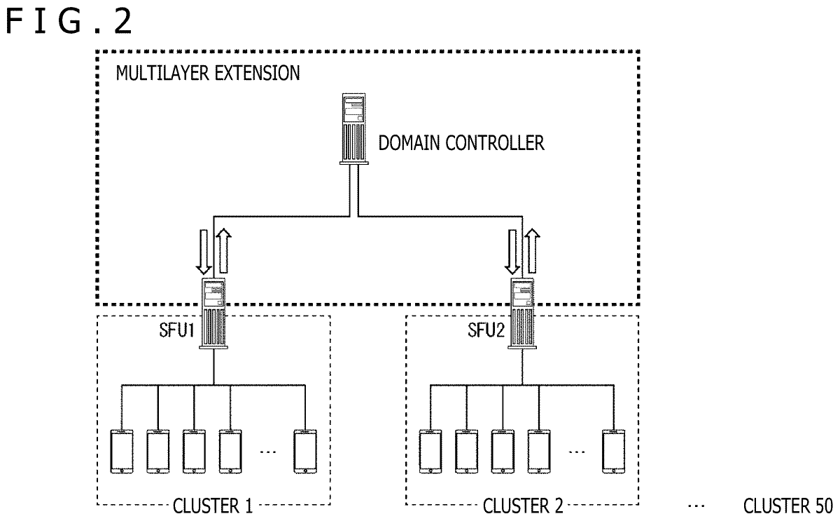

FIG. 2 is a diagram illustrating an example of a layered structure applied to a network system according to an embodiment of the present technology.

As illustrated in FIG. 2, up to 50 clients are connected to an SFU 1. In the example illustrated in FIG. 2, smartphones are employed as clients. The clients connected to the SFU 1 constitute a cluster 1. Communication between the SFU 1 and each of the clients of the cluster 1 is established via the Internet.

In the manner described above, up to 50 clients are connected to an SFU 2. The clients connected to the SFU 2 constitute a cluster 2. Communication between the SFU 2 and each of the clients of the cluster 2 is established via the Internet.

As with the clusters 1 and 2, up to 50 clients connected to one corresponding SFU constitute each of clusters. Up to 50 clusters are formed in the network system.

The network system illustrated in FIG. 2 includes a domain controller provided as an information processing device in a layer higher than the SFUs. Each of the SFUs and the domain controller include a server of a cloud service such as AWS.

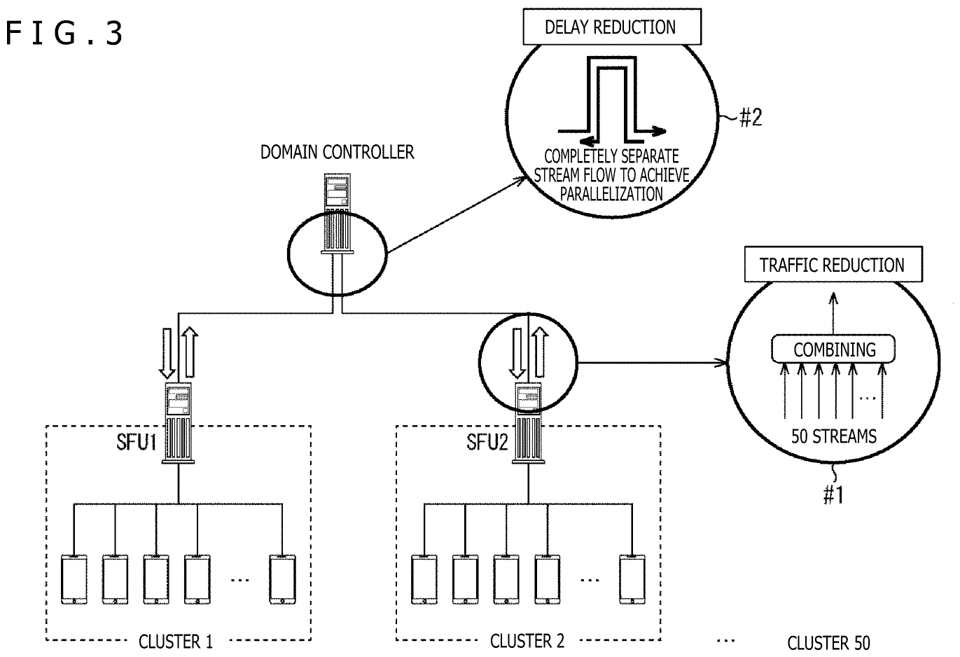

FIG. 3 is a diagram illustrating an example of data transmission and reception.

As indicated in a balloon #1, pieces of data (streams) transmitted from the respective clients to the SFU are combined into one stream by the SFU. In a case where one cluster is constituted by 50 clients, 50 streams are combined into one stream, and transmitted from the SFU to the domain controller. In this case, more traffic reduction is achievable than in a case where 50 streams transmitted from the respective clients are transferred to the domain controller via the SFU without change.

As described above, one stream is transmitted and received between each of the SFUs and the domain controller. One stream transmitted from the domain controller to the SFU is branched and transmitted from the SFU to the clients.

As indicated in a balloon #2, a stream transmitted from the SFU 1 to the domain controller and a stream transmitted from the SFU 2 to the domain controller are separated from each other and processed in parallel in the domain controller. The stream transmitted from the SFU 1 is transferred to the SFU 2 via the domain controller. Meanwhile, the stream transmitted from the SFU 2 is transferred to an SFU 3 via the domain controller.

Processing is performed for the stream received from the SFU 1 and the stream received from the SFU 2 and in a state separated from each other. Accordingly, delay reduction is achievable. Buffers for the streams coming from the respective SFUs are prepared for the domain controller, for example, and paths for the respective streams are separately provided for the domain controller.

A plurality of clusters each constituted by 50 clients or fewer are connected to each other with use of the domain controller and the SFUs. In this manner, 98% of the above values of the downstream traffic can be reduced, and improvement of capacity up to 100,000 persons is achievable in principle.

Assuming that the number of participants is N, a downstream traffic ratio of the system according to the present technology to that of a conventional system is represented by the following expression.

$$( 49 \times 50 + N ) / ( 50 ( N - 1 ) )$$

Presented below are reduction amounts of downstream traffic.
51.5% for 100 persons
6.9% for 1,000 persons
2.5% for 10,000 persons
2.0% for 100,000 persons

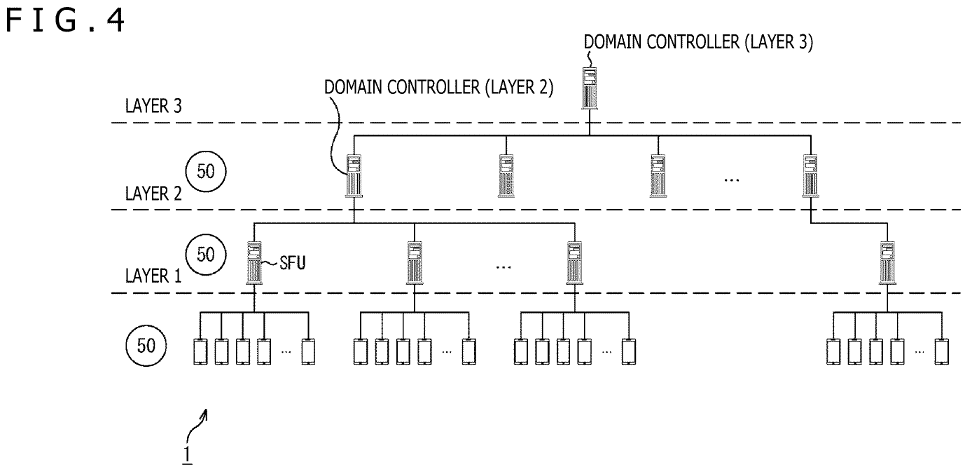

FIG. 4 is a diagram illustrating a configuration example of a network system according to an embodiment of the present technology.

A network system 1 in FIG. 4 has a three-layered configuration on the server side. One domain controller constitutes a host in a layer 3. A plurality of domain controllers constituting hosts in a layer 2 are connected to the domain controller in the layer 3. Moreover, each of the domain controllers in the layer 2 is connected to a plurality of corresponding SFUs constituting hosts in a layer 1. Each of the SFUs is connected to a plurality of corresponding clients constituting a cluster as described above.

When 50 nodes are provided for each of the layers, 50×50×50=125,000 clients are connectable to the service.

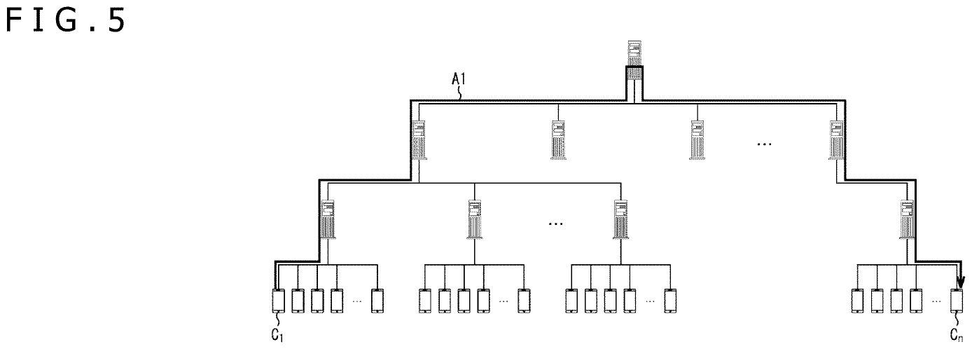

As indicated by an arrow A1 in FIG. 5, data transmitted from a client C1 passes through the SFU in the layer 1 and the domain controller in the layer 2, and reaches the domain controller in the layer 3. In addition, data having reached the domain controller in the layer 3 passes through the domain controller in the layer 2 and the SFU in the layer 3, and is transmitted to a client Cn. The server side configuration having three layers at most can reduce delay to only 150 milliseconds or shorter even for a longest path as indicated by the arrow A1.

A metaverse service is provided by the network system 1 configured as described above. The configuration in FIG. 4 can increase the number of users allowed to simultaneously participate in the service to 100,000 or larger.

### 2. Low-Delay Synchronization Communication Technology Based on Behavior Prediction in Metaverse Virtual Space

### <Dynamic Change of Cluster>

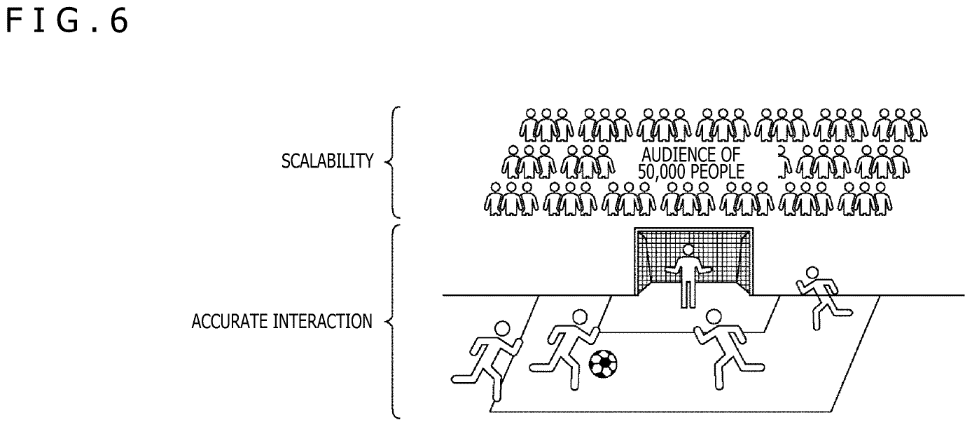

FIG. 6 is a diagram illustrating an example of a metaverse virtual space.

A metaverse virtual space illustrated in FIG. 6 is a virtual space including a three-dimensional model of a soccer stadium. Each of users can operate an avatar as a player participant playing soccer, or as an audience participant watching a game of soccer. The network system 1 prepares various types of virtual spaces, such as a virtual space of a concert venue, a virtual space of a town, and a virtual space of an office, as well as the virtual space of the soccer stadium.

As illustrated in FIG. 6, management of the users as player participants requires accurate interaction, while management of the users as audience participants requires scalability.

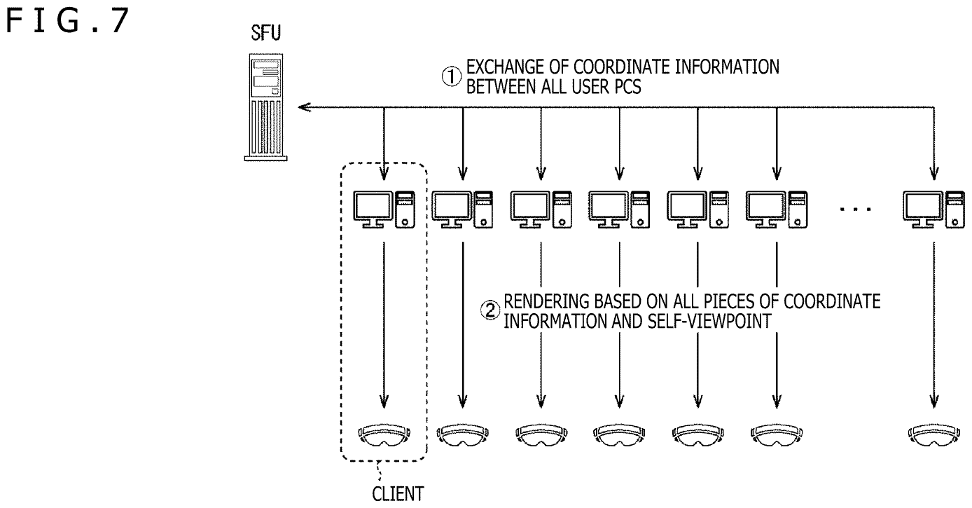

FIG. 7 is a diagram illustrating an example of data transmission and reception.

Metaverse virtual spaces, including a soccer stadium, are each realized by mutual exchange of position information (coordinate information) between all of clients and rendering based on all pieces of the position information and self-viewpoints. The exchange of the position information between the users is achieved via the server side configuration such as SFUs. According to the example in FIG. 7, each of the clients includes a PC and an HMD.

According to the network system 1, the network is divided in accordance with characteristics of the metaverse virtual space, and a synchronization frequency of position information is set for each of divisions.

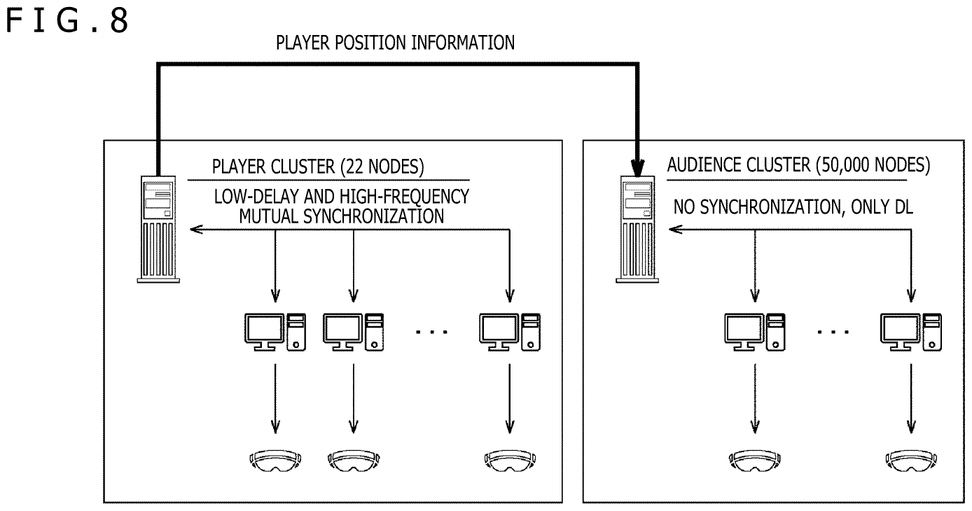

FIG. 8 is a diagram illustrating a configuration example of the network.

According to the network system 1 providing a metaverse virtual space of a soccer stadium, user clients (nodes) as player participants and user clients as audience participants are managed as clients belonging to different clusters as illustrated in FIG. 8.

For example, a player cluster corresponding to a cluster of the user clients as player participants includes the same number of 22 nodes as the number of players. The 22 clients constituting the player cluster are connected to one SFU. The player cluster is a cluster requiring low-delay and high-frequency mutual synchronization of pieces of position information. In a case of a soccer game, synchronization of pieces of position information with low delay not exceeding 10 milliseconds is required in general.

Meanwhile, an audience cluster corresponding to a cluster of the user clients as audience participants includes the same number of 50,000 nodes as the number of persons of the audience, for example. The 50,000 clients constituting the audience cluster are connected to a server having a layered structure as described above. The audience cluster is a cluster to which each position information is downloaded without synchronization of the pieces of position information.

According to the network system 1, the configuration of the player cluster which requires low-delay and high-frequency mutual synchronization of pieces of position information is dynamically variable. The player cluster is divided into a plurality of clusters as necessary.

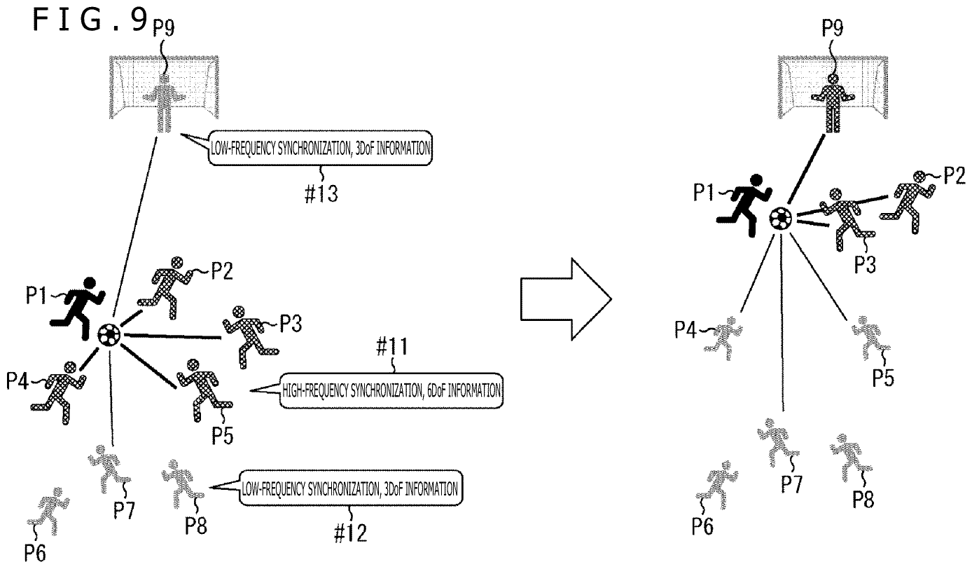

FIG. 9 is a diagram illustrating an example of movement of players.

A player P1 illustrated in a left part in FIG. 9 is a player holding and dribbling a ball. Players P2 to P5 are present around the player P1 holding the ball. Moreover, players P6 to P9 are located away from the player P1. A player P9 is a goalkeeper. More players are located away from the player P1.

For example, clients of five users operating the players P1 to P5 constitute a player cluster, while clients of 17 users operating the players away from the player P1 constitute a player cluster different from the player cluster of the players P1 to P5.

As indicated in a balloon #11, low-delay and high-frequent synchronization of pieces of position information is achieved between the clients of the five users operating the players P1 to P5. As the pieces of position information to be mutually synchronized, 6 DoF (Degree of Freedom) information (degree of freedom) is employed.

Meanwhile, as indicated in balloons #12 and #13, low-frequency synchronization of pieces of position information is achieved between the clients of the 17 users other than the players P1 to P5. As the pieces of position information to be mutually synchronized, 3 DoF information is employed.

As described above, the player cluster is divided into a cluster where low-delay and high-frequency synchronization of pieces of position information is achieved and a cluster where low-frequency synchronization of pieces of position information is achieved. Hereinafter, the former cluster will be referred to as a high-frequency synchronization player cluster, and the latter cluster will be referred to as a low-frequency synchronization player cluster, as appropriate. The clients constituting the high-frequency synchronization player cluster and the clients constituting the low-frequency synchronization player cluster are dynamically variable in accordance with behaviors of the respective players.

For example, assumed is a case where the player P1, who is approaching the goal while dribbling, is located close to the player P9 while the player P4 and the player P5 are located away from the player P1, as illustrated in a right part in FIG. 9. The player P2 and the player P3 remain close to the player P1.

In this case, the players P1 to P3 and P9 constitute a high-frequency synchronization player cluster, and the players other than the players P1 to P3 and P9 constitute a low-frequency synchronization player cluster. In this manner, the configurations of the player clusters dynamically vary. Low-delay and high-frequency synchronization of pieces of position information is achieved between the players P1 to P3 and P9, while low-frequency synchronization of pieces of position information is achieved between the other players.

As described above, the network system 1 divides the network in accordance with domain characteristics, and sets a synchronization frequency of position information for each division. Moreover, synchronization characteristics (frequency and density) of the respective clusters are dynamically variable in accordance with such factors as a level of a relation with a PoI (Point of Interest; the person holding the ball in this example). The level of the relation with the POI is determined in accordance with a distance, a direction, an attribute of the player (offense or defense), or other factors.

The division into the player cluster and the audience cluster and the further division of the player cluster in accordance with the synchronization characteristics can prevent interaction deviation between participants in the metaverse virtual space.

### <Switching of Connection Destination SFU>

Individual clients are connected to one SFU which manages a cluster to which these individual clients belong. In a case where the configuration of the network dynamically varies as described above, the SFU corresponding to the connection destination of the individual clients may be switched to a different SFU.

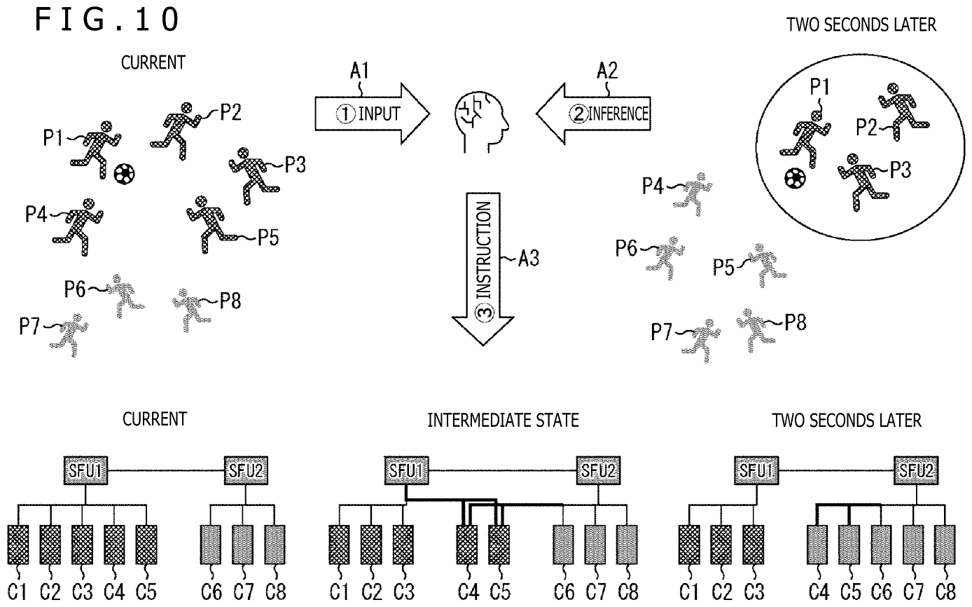

FIG. 10 is a diagram illustrating an example of a variable configuration of the network configuration.

Illustrated in a left part in FIG. 10 are a current situation of the players and a network configuration corresponding to this situation. The current situation of the players is such a situation where the player P1 holding and dribbling the ball is surrounded by the players P2 to P5. The players P6 to P8 are located at positions away from the player P1. While described herein is an example based on behaviors of the players P1 to P8, behaviors of the other players also influence the network configuration. Clients C1 to C8 are clients operated by the players P1 to P8, respectively.

In this case, a player cluster constituted by the clients C1 to C5 is different from a player cluster constituted by the clients C6 to C8 as illustrated in a lower left part in FIG. 10. The player cluster constituted by the clients C1 to C5 is a high-frequency synchronization player cluster, while the player cluster constituted by the clients C6 to C8 is a low-frequency synchronization player cluster. The clients C1 to C5 are connected to the SFU 1, while the clients C6 to C8 are connected to the SFU 2. Position information is transmitted and received between the SFU 1 and the SFU 2.

According to the network system 1, a future situation of the players is predicted on the basis of a current situation of the players, and the network configuration is dynamically controlled as anticipation in a sense on the basis of a prediction result, for example. For example, the future situation of the players is inferred with use of a model generated beforehand by machine learning. Prepared for the network system 1 is such an inference model which receives input of a current situation of the players and outputs a near future situation of the players, such as a situation after two seconds.

As indicated by arrows A1 and A2, information indicating a current situation of the players and a future situation of the players is input to the network system 1 (an Interaction Inferencer described below). Control signals designating the network configuration are generated by the domain controller on the basis of the current situation of the players and the future situation of the players, and are transmitted to the devices.

Illustrated in an upper right part in FIG. 10 is a situation of the players after two seconds as predicted by behavior prediction. As the situation after two seconds, a situation surrounded by a circle, i.e., a situation where the player P2 and the player P3 are present around the player P1, is predicted. It is further predicted that the player P4 and the player P5 around the player P1 in the current situation will move to positions away from the player P1.

In this case, the client C4 and the client C5 are brought into connection with not only the SFU 1 but also SFU 2 as indicated at a destination of an arrow A3. This state is produced as an intermediate state of the network configuration. In the intermediate state, communication between the clients C4 and C5 and the SFU 1 is active. Communication between the clients C4 and C5 and the SFU 2 is inactive even in a session-established state.

In a case where the prediction result is correct, i.e., the current situation shifts to the situation illustrated in the upper right part in FIG. 10 two seconds later from the current time, communication between the clients C4 and C5 and the SFU 1 is cut off as indicated in a lower right part in FIG. 10, and communication between the clients C4 and C5 and the SFU 2 is active. In this state, the clients C1 to C3 constitute a high-frequency synchronization player cluster, and the clients C4 to C8 constitute a low-frequency synchronization player cluster.

As described above, the network system 1 performs such control which achieves duplication in an intermediate state and cuts off the original session two seconds later if inference is correct, so as to seamlessly execute connection switching of the session.

### <Application Example of Other Domains>

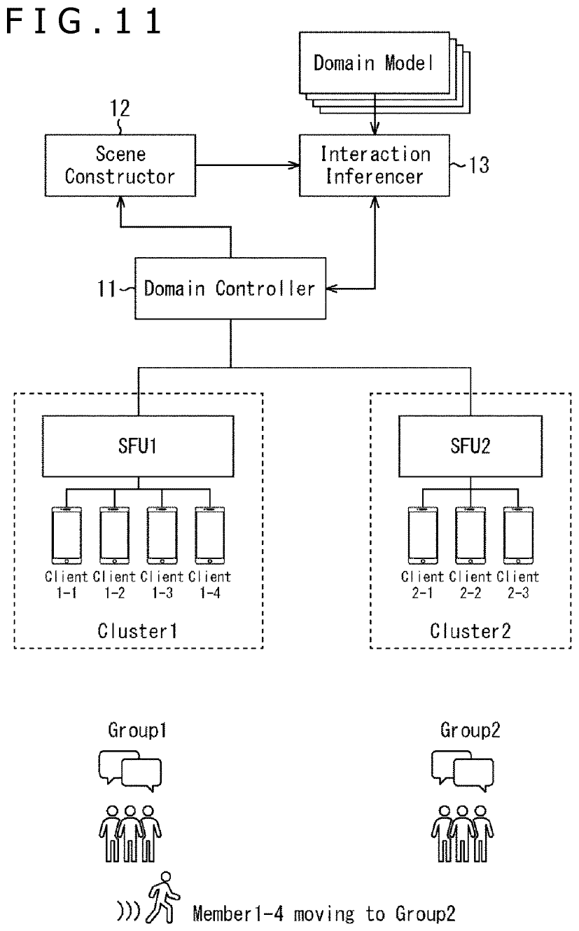

FIG. 11 is a diagram illustrating a configuration example of the network system 1 which dynamically controls the network configuration. FIG. 11 illustrates a part of the configuration of the network system 1.

In the example illustrated in FIG. 11, the SFU 1 and the SFU 2 are connected to a Domain Controller 11.

The function of the Domain Controller 11 may be implemented either by one of the Domain Controllers in the layer 2, or by the Domain Controller in the layer 3. In a case where the function of the Domain Controller 11 is implemented by the Domain Controller in the layer 3, the Domain Controller 11 is connected to the SFU 1 and the SFU 2 via the Domain Controller in the layer 2. This configuration is also applicable to other figures not illustrating layered structures.

Clients 1-1 to 1-4 constitute a Cluster 1 managed by the SFU 1, while Clients 2-1 to 2-3 constitute a Cluster 2 managed by the SFU 2. Members 1-1 to 1-4 provided as avatars operated by the users of the Clients 1-1 to 1-4, respectively, constitute a Group 1, and Members 2-1 to 2-3 provided as avatars operated by the users of the Clients 2-1 to 2-3, respectively, constitute a Group 2. The Group 1 and the Group 2 are each a group of avatars.

### A Scene Constructor 12 and an Interaction

Inferencer 13 are connected to the Domain Controller 11. The functions of the respective parts will be described below.

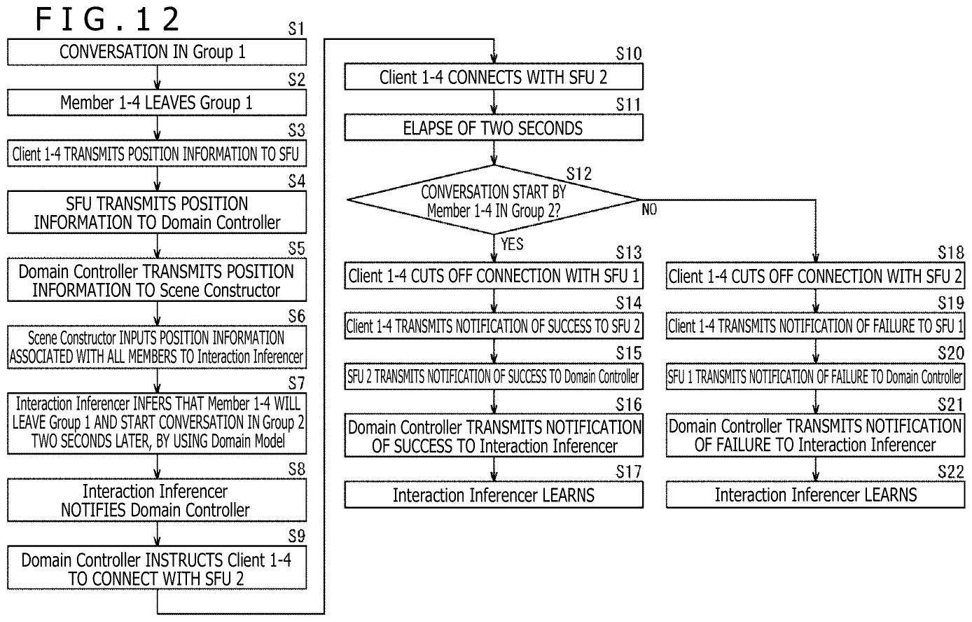

A process performed by the network system 1 to achieve dynamic control of the network configuration will be described with reference to a flowchart in FIG. 12. Discussed herein will be control performed in response to movement of the Member 1-4 of the Group 1 to the Group 2.

In step S1, the Member 1-4 converses with a different member in the Group 1. A voice of the Member 1-4 is transmitted to the Clients 1-1 to 1-3 corresponding to clients of the other members in the Cluster 1.

In step S2, the Member 1-4 leaves the Group 1.

In step S3, the Client 1-4 transmits position information associated with the Member 1-4 to the SFU 1.

In step S4, the SFU 1 transmits the position information associated with the Member 1-4 to the Domain Controller 11.

In step S5, the Domain Controller 11 transmits the position information associated with the Member 1-4 and transmitted from the SFU 1, to the Scene Constructor 12.

In step S6, the Scene Constructor 12 receives the position information associated with the Member 1-4 and transmitted from the Domain Controller 11, and inputs pieces of position information associated with all members to the Interaction Inferencer 13.

In step S7, the Interaction Inferencer 13 infers that the Member 1-4 will leave the Group 1 and start conversation in the Group 2 two seconds later, by using a Domain Model. Domain Models are prepared for the Interaction Inferencer 13 as inference models for predicting behaviors of avatars in metaverse virtual spaces (domains).

In step S8, the Interaction Inferencer 13 notifies the Domain Controller 11 of an inference result.

In step S9, the Domain Controller 11 instructs the Client 1-4 to connect with the SFU 2. A control signal is transmitted to the Client 1-4 to instruct connection with the SFU 2.

In step S10, the Client 1-4 connects with the SFU 2. This state corresponds to an intermediate state where the Client 1-4 is connected with the SFU 1 and the SFU 2.

In step S11, the Domain Controller 11 waits two seconds.

In step S12, the Domain Controller 11 determines whether or not the Member 1-4 has started conversation in the Group 2. In a case where it is determined in step S12 that the Member 1-4 has started conversation in the Group 2, the process proceeds to step S13.

In step S13, the Client 1-4 cuts off connection with the SFU 1.

In step S14, the Client 1-4 transmits a notification of connection success to the SFU 2.

In step S15, the SFU 2 transmits a notification of connection success of the Client 1-4 to the Domain Controller 11.

In step S16, the Domain Controller 11 transmits a notification of connection success between the Client 1-4 and the SFU 2 to the Interaction Inferencer 13.

In step S17, the Interaction Inferencer 13 learns parameters of an inference model. For example, information indicating correctness of the inference that the Member 1-4 will move to the Group 2 and start conversation is used for learning of the parameters of the inference model.

Meanwhile, in a case where it is determined in step S12 that the Member 1-4 does not start conversation in the Group 2, the process proceeds to step S18.

In step S18, the Client 1-4 cuts off connection with the SFU 2.

In step S19, the Client 1-4 transmits a notification of connection failure to the SFU 1.

In step S20, the SFU 1 transmits a notification of connection failure of the Client 1-4 to the Domain Controller 11.

In step S21, the Domain Controller 11 transmits a notification of connection failure of the Client 1-4 to the Interaction Inferencer 13.

In step S22, the Interaction Inferencer 13 learns parameters of an inference model. For example, information indicating incorrectness of the inference that the Member 1-4 will move to the Group 2 and start conversation is used for learning of the parameters of the inference model.

After completion of leaning of the parameters of the inference model in step S17 or step S22, the process ends.

The network system providing services in a metaverse virtual space is constructed to achieve synchronization of pieces of position information and pieces of behavior information associated with respective avatars between all participants in a fixed cycle. Accordingly, with an increase in the number of participants, desynchronization may be caused by a bottleneck of synchronous communication transaction. The desynchronization thus caused produces deviation of positions or movements of the other side of the interaction, making it impossible to achieve coordinated behaviors.

According to the present technology, clients are clustered in accordance with probability levels of interactions, and reduction of transactions and reduction of desynchronization are achievable by limiting a range requiring highly frequent synchronization.

Moreover, a group which will cause an interaction after a fixed period is inferred on the basis of behaviors of avatars, and the network configuration is dynamically controlled to hand over a session of clients by anticipation. In this manner, the cluster configuration can seamlessly be varied by movement of the avatars.

### <Summary of Network Configuration>

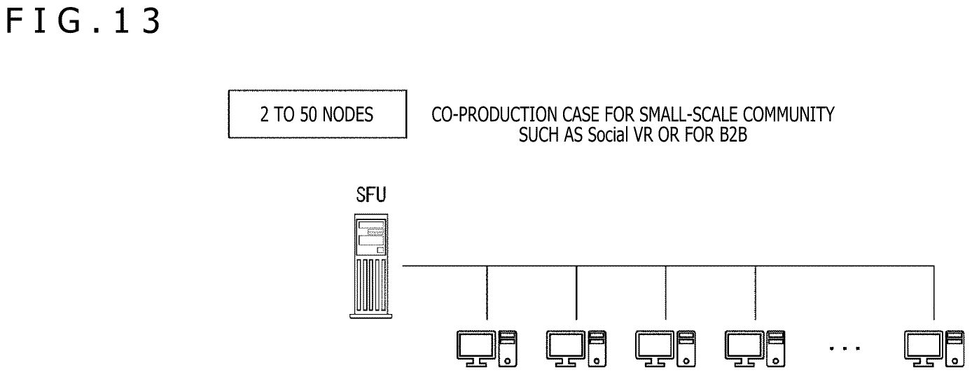

Each of FIGS. 13 to 15 is a diagram illustrating an example of the network configuration.

As illustrated in FIG. 13, one SFU is provided for a network presenting a domain including 2 to 50 nodes of participants. All clients are connected to the one SFU. For example, such a domain is a domain of a co-production case for small-scale community such as social VR or for B2B.

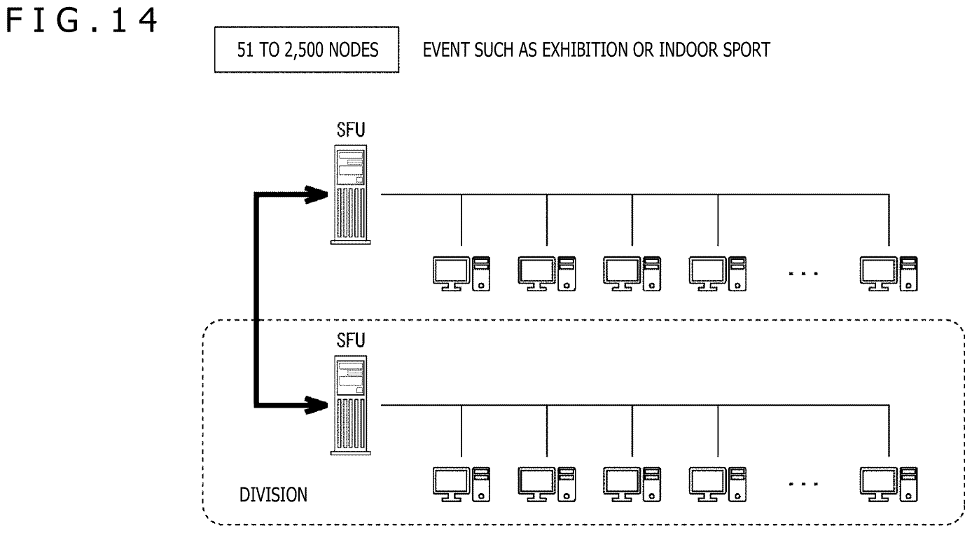

As illustrated in FIG. 14, a plurality of SFUs are provided for a network presenting a domain having 51 to 2,500 nodes of participants. Each of the SFUs is connected to a domain controller. Clients of up to 50 nodes constituting each cluster are connected to one SFU. For example, such a domain is a domain of an event such as an exhibition or of an indoor sport.

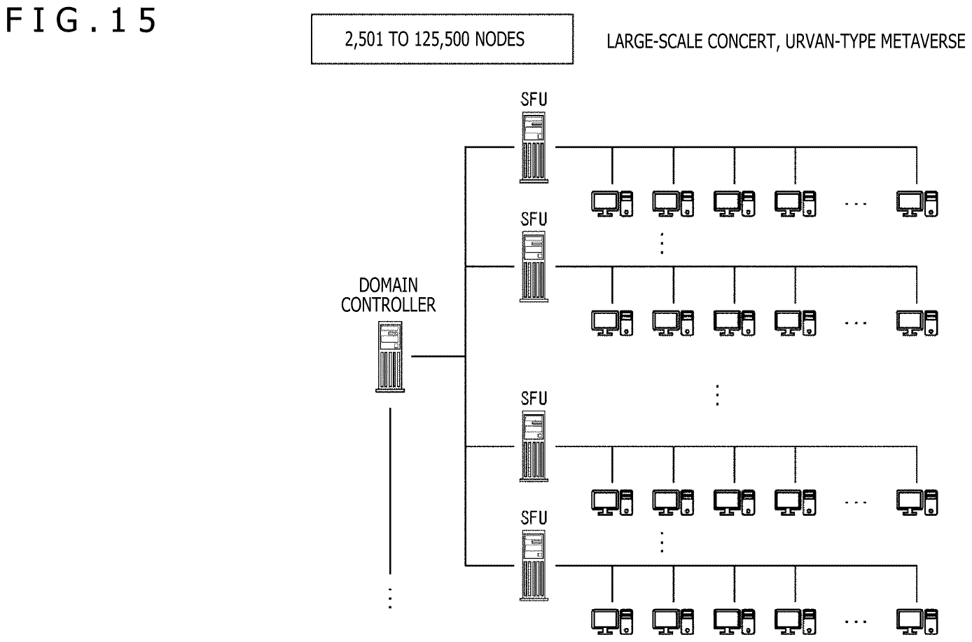

As illustrated in FIG. 15, a plurality of SFUs are provided for a network presenting a domain having 2,501 to 125,000 nodes of participants. The respective SFUs constituting hosts in the layer 1 are connected to a domain controller constituting a host in the layer 2. Clients of up to 50 nodes constituting each cluster are connected to one SFU. For example, such a domain is a domain of a large-scale concert or of an urban-type metaverse.

### 3. Sound Transmission Effect Control Technology Based on Distance and Structure in Metaverse Virtual Space

### <Arrangement of Avatars>

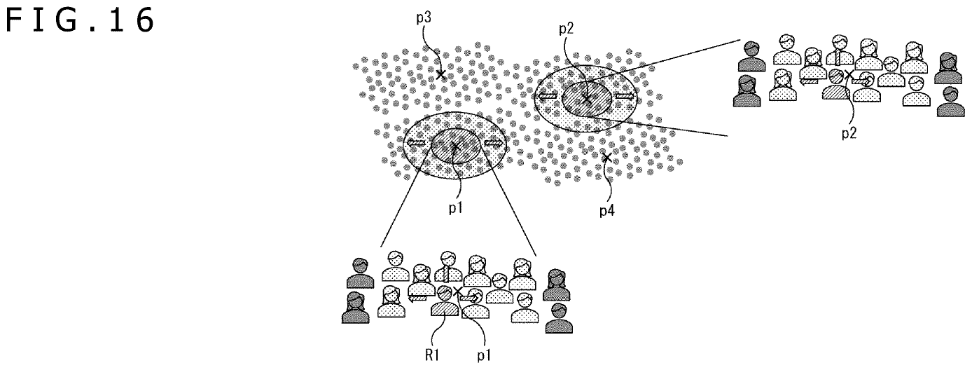

FIG. 16 is a diagram illustrating an example of arrangement of avatars.

FIG. 16 illustrates an arrangement example of avatars on audience seats in a concert venue. The present technology is also applicable to sound processing in a different metaverse virtual space, such as sound processing on audience seats in the soccer stadium discussed above.

Each dot illustrated in an upper left part in FIG. 16 represents an avatar of a participant as a spectator. A large number of avatars, such as 10,000 avatars, are arranged in the concert venue. Among the 10,000 avatars, 1,000 avatars are operated by real users, for example. The remaining 9,000 avatars are virtual avatars created by AI (a model created by machine learning) in the network system 1, for example. Hereinafter, the avatars operated by the real users will be referred to as real avatars, and the virtual avatars created in the network system 1 will be referred to as virtual avatars, as appropriate.

The real avatars are collected and arranged in a plurality of areas of the whole audience seats. According to the example in FIG. 16, 10 real avatars are arranged in each of an area #1 around a center of a position p1 and an area #2 around a center of a position p2. Avatars arranged outside the areas #1 and #2 defined as elliptical areas are virtual avatars.

Each of the users of the clients can appreciate the concert in the concert venue through the real avatars corresponding to other selves, cheer, and converse with the user operating the adjoining real avatar.

Not only a sound of an avatar of an artist performing the concert and a performance sound but also sounds of different avatars reach a position of one real avatar. For example, not only sounds of the different real avatars (sounds of users of different real avatars) arranged in the same area #1 but also sounds of the real avatars arranged in the area #2 reach a position of a real avatar R1 arranged in the area #1. Sounds from other areas in which real avatars are arranged also reach the real avatar R1.

Moreover, sounds from virtual avatars arranged at respective positions also reach the position of the real avatar R1. Sounds corresponding to types of events occurring in the concert venue, such as cheers and stamping sound, are output as sounds of the virtual avatars. For example, sounds created by AI are output as sounds of the virtual avatars.

An inference model to which sounds of the real avatars are input and from which sounds of the virtual avatars are output is prepared for the network system 1. For example, the inference model used for creating sounds of the virtual avatars is trained with use of crowd sound data recorded in a real concert venue and labeled.

Sounds of the real avatars are output from the areas #1 and #2, and sounds at respective positions other than the areas #1 and #2 are interpolated by sounds of the virtual avatars. In this manner, sounds are output from the whole audient seats.

Stereophonic processing corresponding to the positions of the avatars is applied to these types of sounds output in the concert venue, and the processed sound is output from the clients of the respective users. The user of the real avatar R1 hears sounds of the different real avatars arranged in the area #1 as sounds emitted from near avatars. Moreover, the user of the real avatar R1 hears sounds of the different real avatars arranged in the area #2 as sounds emitted from avatars located at predetermined distances from the user. Further, the user of the real avatar R1 hears sounds of virtual avatars arranged at positions p3 and p4 as sounds emitted from avatars located at the corresponding positions.

For example, the stereophonic processing is achieved by applying, to sound data, calculation using parameters representing audio transmission characteristics concerning sounds from respective sound sources and obtained at respective hearing positions. Signal processing is performed in accordance with distances between the sound source positions and the hearing positions and the structure of the metaverse virtual space. The hearing positions and the sound source positions are specified on the basis of position information associated with the avatars.

In this manner, even in a case where 1,000 users participate in the concert venue by operating real avatars, sounds of an environment including a large audience, such as 10,000 people, can be reproduced. As described above, the number of users simultaneously connectable with the metaverse virtual space provided by the network system 1 is more than 100,000. A crowd sound as if being emitted from more than 1,000,000 participants can be reproduced in one metaverse virtual space such as a music live concert and a sport watching spot.

### <Process by Network System 1>

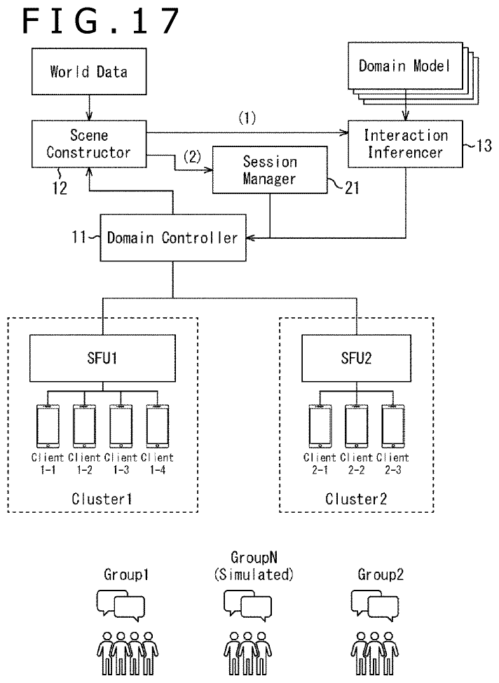

FIG. 17 is a diagram illustrating a configuration example of the network system 1 performing sound output control. Configurations already described with reference to FIG. 11 and other figures are given identical reference signs. Repetitive description will be omitted where appropriate.

The Clients 1-1 to 1-4 constitute the Cluster 1 managed by the SFU 1, while the Clients 2-1 to 2-3 constitute the Cluster 2 managed by the SFU 2. The Members 1-1 to 1-4 provided as avatars operated by the users of the Clients 1-1 to 1-4 constitute the Group 1, and the Members 2-1 to 2-3 provided as avatars operated by the users of the Clients 2-1 to 2-3 constitute the Group 2.

The Group 1 and the Group 2 are each a group of real avatars. In an actual situation, one Group is constituted by 10 real avatars. Meanwhile, a Group N illustrated in a lower part in FIG. 17 is a group of virtual avatars.

The Scene Constructor 12, the Interaction Inferencer 13, and a Session Manager 21 are connected to the Domain Controller 11.

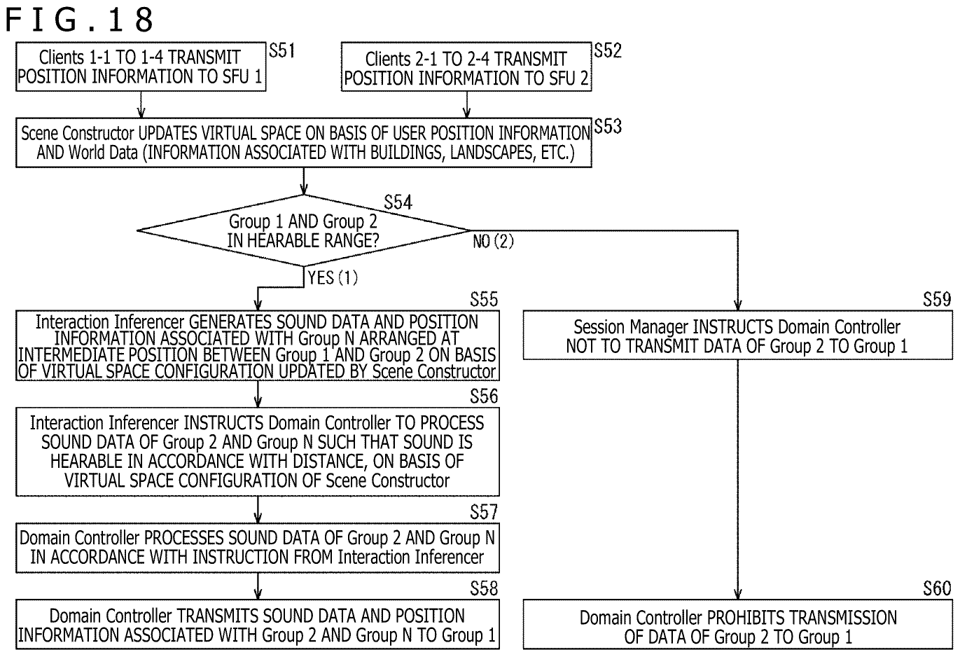

A process performed by the network system 1 to control sound output will be described with reference to a flowchart in FIG. 18.

In step S51, the Clients 1-1 to 1-4 transmit position information associated with the avatars operated by the corresponding users to the SFU 1.

In step S52, the Clients 2-1 to 2-3 transmit position information associated with the avatars operated by the corresponding users to the SFU 2.

In step S53, the Scene Constructor 12 updates an environment of a metaverse virtual space on the basis of position information associated with the avatars and World Data (information associated with buildings, landscapes, etc.).

In step S54, the Scene Constructor 12 determines whether the distance between the Group 1 and the Group 2 is contained in a hearable range. In a case where the distance between the Group 1 and the Group 2 is a threshold or shorter, for example, it is determined in step S54 that this distance is contained in the hearable range, and the process proceeds to step S55.

In step S55, the Interaction Inferencer 13 generates sound data and position information associated with the Group N arranged at an intermediate position between the Group 1 and the Group 2. The sound data and the position information associated with the Group N are generated on the basis of the configuration of the metaverse virtual space updated by the Scene Constructor 12.

In step S56, the Interaction Inferencer 13 instructs the Domain Controller 11 to process the sound data of the Group 2 and the sound data of the Group N such that a sound is heard in a manner corresponding to distances of the respective groups. The sound data is processed on the basis of the configuration of the metaverse virtual space updated by the Scene Constructor 12.

In step S57, the Domain Controller 11 processes the sound data of the Group 2 and the Group N in accordance with the instruction from the Interaction Inferencer 13.

In step S58, the Domain Controller 11 transmits the sound and the position information associated with the Group 2 and the Group N to each of the clients of the Group 1.

Meanwhile, in a case where it is determined that the distance between the Group 1 and the Group 2 is not contained in the hearable range, the Session Manager 21 in step S59 instructs the Domain Controller 11 not to transmit the data of the Group 2 to the clients of the Group 1.

In this case, the Domain Controller 11 in step S60 performs control to prohibit transmission of the data of the Group 2 to the clients of the Group 1. After completion of step S58 or step S60, the process in FIG. 18 ends.

As described above, avatars of real participants (real avatars) are effectively arranged in a metaverse virtual space, and a sound outside an area in which the real avatars are arranged is created and output. In this manner, a highly realistic crowd sound can be reproduced. A sound created using an inference model produced as a result of learning using crowd sound data recorded in various domains and labeled is output as a sound outside the area in which the real avatars are arranged. Accordingly, a reality level of a sound improves.

### 4. System Configuration

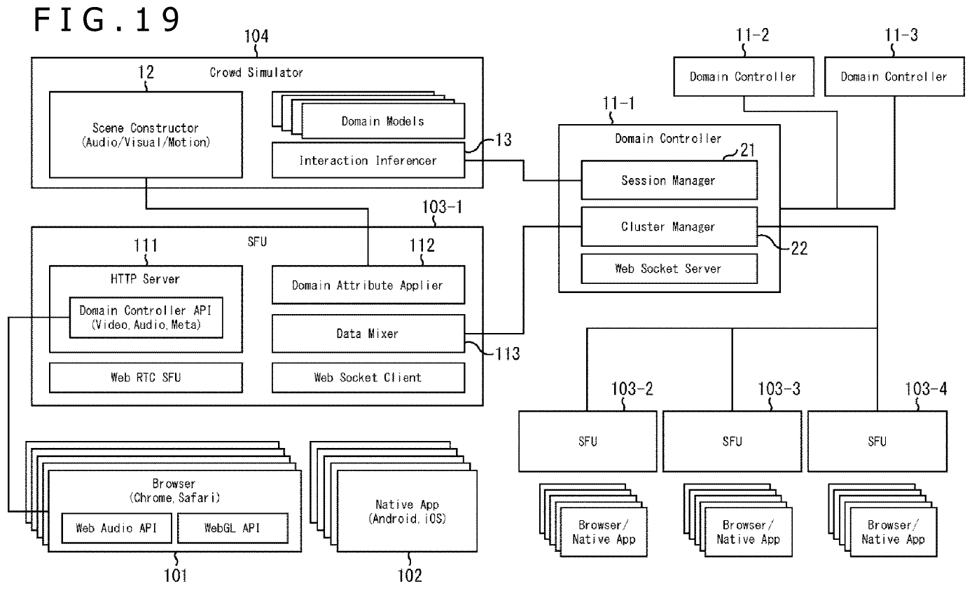

FIG. 19 is a block diagram illustrating a configuration example of the network system 1. A main configuration will be discussed with reference to FIG. 19. The same description as the above will be omitted where appropriate.

A Browser 101 and a Native App 102 illustrated in a lower left part in FIG. 19 constitutes each client. The Browser 101 operates in the Native App 102. The Browser 101 communicates with an HTTP Server 111 of an SFU 103-1.

For example, the Browsers 101 of 50 clients are connected with the HTTP Server 111 of the SFU 103-1. Similarly, Browsers of 50 clients are connected to each of the SFU 103-2 to 103-4.

The SFU 103-1 includes the HTTP Server 111, a Domain Attribute Applier 112, and a Data Mixer 113. The Domain Attribute Applier 112 communicates with the Scene Constructor 12 of a Crowd Simulator 104. The Data Mixer 113 combines information transmitted from a plurality of clients constituting a cluster, and transmits the combined information to the Domain Controller 11.

The Crowd Simulator 104 includes the Scene Constructor 12 and the Interaction Inferencer 13.

A Domain Controller 11-1 includes the Session Manager 21 and a Cluster Manager 22. The Cluster Manager 22 communicates with the SFUs to control a cluster configuration. The Cluster Manager 22 performs dynamic control of the cluster. Any one of the Domain Controllers 11-1 to 11-3 functions as a Domain Controller in the layer 3.

The Domain Controllers 11-1 to 11-3, the SFUs 103-1 to 103-4, and the Crowd Simulator 104 each include a computer. Different computers are used to constitute the Domain Controllers 11-1 to 11-3, the SFUs 103-1 to 103-4, and the Crowd Simulator 104, for example. The same computer may be used to constitute at least some of the Domain Controllers 11-1 to 11-3, the SFUs 103-1 to 103-4, and the Crowd Simulator 104.

### 5. Others

### <Configuration Example of Computer>

A series of processes described above may be executed by either hardware or software. For executing the series of processes by software, a program constituting this software is installed from a program recording medium into a computer incorporated in dedicated hardware, a general-purpose personal computer, or the like.

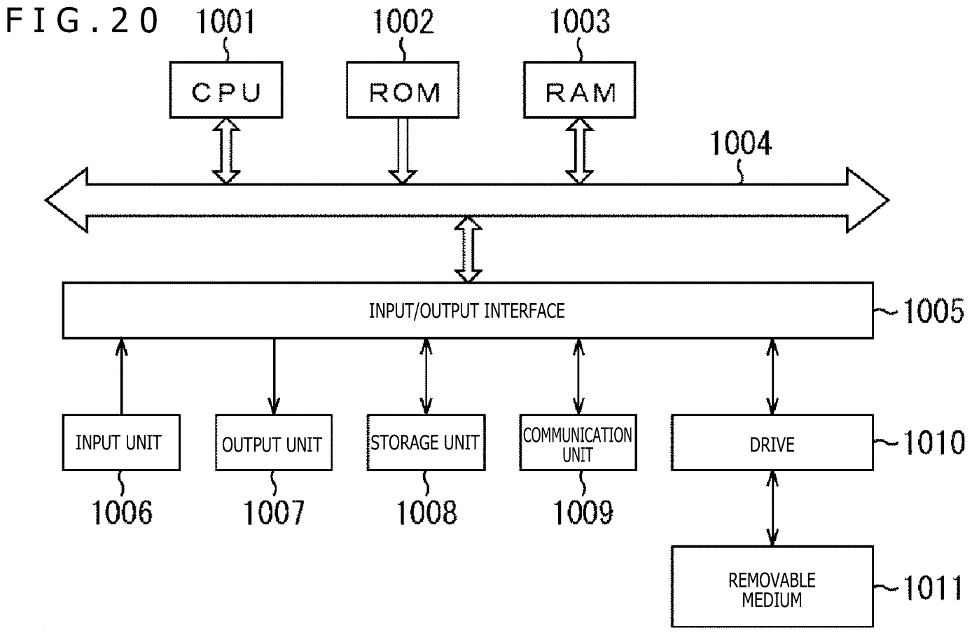

FIG. 20 is a block diagram illustrating a configuration example of hardware of a computer which executes the processes described above under the program. For example, the Domain Controllers 11 (11-1 to 11-3), the SFUs 103-1 to 103-4, and the Crowd Simulator 104 each include the computer having the configuration illustrated in FIG. 20.

A CPU (Central Processing Unit) 1001, a ROM (Read Only Memory) 1002, and a RAM (Random Access Memory) 1003 are connected to one another via a bus 1004.

An input/output interface 1005 is further connected to the bus 1004. An input unit 1006 including a keyboard, a mouse, and others and an output unit 1007 including a display, a speaker, and others are connected to the input/output interface 1005. Moreover, a storage unit 1008 including a hard disk, a non-volatile memory, and others, a communication unit 1009 including a network interface and the like, and a drive 1010 driving a removable medium 1011 are connected to the input/output interface 1005.

According to the computer configured as above, the CPU 1001 loads a program stored in the storage unit 1008, for example, into the RAM 1003 via the input/output interface 1005 and the bus 1004, and executes the loaded program to perform the series of processes described above.

For example, the program executed by the CPU 1001 is recorded in the removable medium 1011, or provided via a wired or wireless transfer medium, such as a local area network, the Internet, and digital broadcasting, and installed in the storage unit 1008.

The program executed by the computer may be a program where processes are performed in time series in accordance with the order described in the present disclosure, or may be a program where processes are performed in parallel or at necessary timing such as timing of a call.

The “system” in the present disclosure refers to a set of a plurality of constituent elements (devices, modules (parts), etc.). In this case, constituent elements of the system may be all contained in an identical housing, or may be contained in different housings. Accordingly, a plurality of devices contained in separate housings and connected to each other via a network and one device including a plurality of modules contained in one housing are both considered as systems. Advantageous effects to be achieved are not limited to those presented in the present disclosure only by way of example. Further, other advantageous effects may be further offered.

Embodiments of the present technology are not limited to the embodiments described above. Various modifications may be made without departing from the scope of the present technology.

For example, the present technology may be practiced in a form of cloud computing where one function is shared and processed by a plurality of devices in cooperation with each other via a network.

Moreover, the steps discussed above with reference to the flowcharts may be executed by one device, or shared and executed by a plurality of devices.

Further, in a case where one step includes a plurality of processes, the plurality of processes included in the one step may be executed by one device, or may be shared and executed by a plurality of devices.

### 6. Volume Control Technology According to Sound Source Position Change in Virtual Space

### <Outline>

Subsequently described will be a volume control technology in a virtual space according to an embodiment of the present disclosure. A virtual space called a metaverse is also utilized as a space where avatars enjoy conversation with each other. In this case, a sense of realism of not only video but also a sound is an important factor for increasing experimental values of the virtual space. For example, in a case where avatars converse with each other while walking in a town, a case where a different avatar comes closer from a distance while speaking, or other cases, a volume of a sound is varied in accordance with a distance from a position of a sound source such as the different speaking avatar to provide immersive sound close to real sound for the user. Specifically, an adjustment corresponding to a distance between a self-position (hearing position) of an avatar and a sound source (different avatar, for example) is set beforehand. In this manner, the sound close to real sound as described above can be produced.

### (System Configuration)

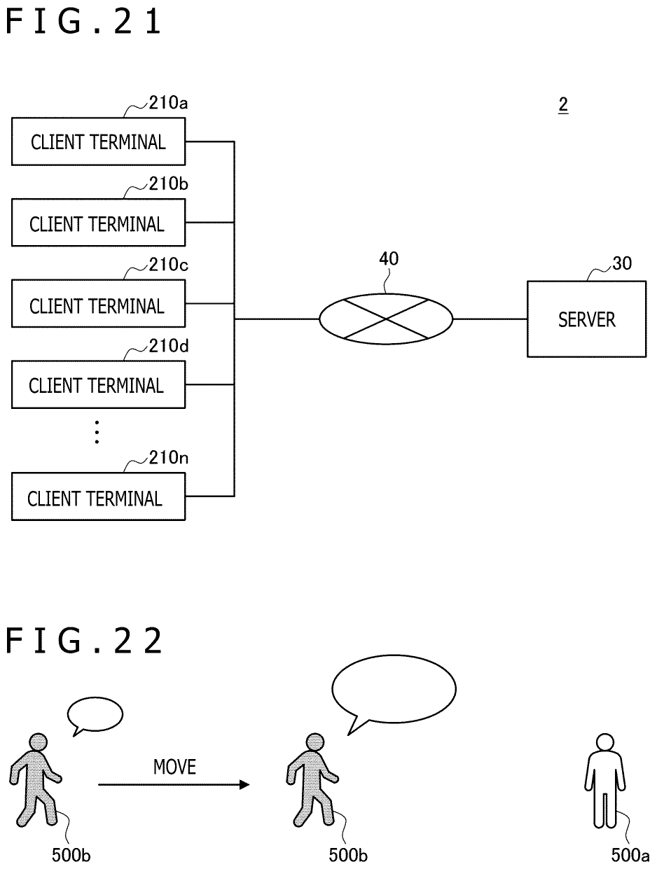

FIG. 21 is a diagram illustrating an example of a configuration of a volume control system according to an embodiment of the present disclosure. As illustrated in FIG. 21, a volume control system 2 includes client terminals 210 (210a to 210n), which are used to operate avatars, and a server 30. The client terminals 210 and the server 30 can be connected to each other via a network 40.

### (Client Terminal 210)

Each of the client terminals 210 can be implemented by a smartphone, a PC, an HMD (Head Mounted Display), or the like. The client terminals 210 can display video representing a virtual space from a viewpoint of the user, on the basis of information received from the server 30. The viewpoint of the user refers to any viewpoint in the virtual space. For example, the viewpoint of the user may be a viewpoint of an avatar that is disposed in the virtual space and that is movable in the virtual space as another self of the user, or may be a bird's eye view for viewing this avatar. Moreover, the client terminals 210 can output a sound in the virtual space on the basis of information received from the server 30.

Each of the client terminals 210 receives various types of operations input to the virtual space from the user, and transmits input information to the server 30. The operations input from the user include operations of an avatar (also referred to as a user avatar) performed by the user. The user can move in the virtual space by operating the user avatar.

Moreover, each of the client terminals 210 acquires a speech voice of the user and transmits the acquired voice to the server 30. Avatars are allowed to have conversation with each other (what is generally called voice chat) in the virtual space. The speech voice (conversation voice) of the user is transmitted and received between the client terminals 210 of the conversing users via the server 30. For example, the voice chat may be achieved in a group constituted by avatars added as friends. The users (avatars) can also converse with friends while walking or playing with friends in the virtual space.

### (Server 30)

The server 30 has a function of forming a virtual space and providing information associated with the virtual space for the client terminals 210. For example, the server 30 transmits information necessary for drawing the virtual space (map information, information associated with various types of objects, etc.) to the client terminals 210 logging in (connecting with) the virtual space, and continuously transmits update information associated with the virtual space (for example, position information associated with different avatars, motion information, etc.) during connection. The server 30 performs control for synchronizing pieces of information associated with the virtual space and handled by the plurality of client terminals 210, to enable a plurality of users to share the virtual space.

The server 30 may generate information for each of video and sounds in the virtual space in accordance with positions of avatars corresponding to the respective client terminals 210 in the virtual space, and transmit the generated information to a corresponding one of the client terminals 210. Rendering of video and sounds may be achieved either by the server 30 or by the client terminals 210.

The server 30 may be a system including a plurality of servers. Moreover, the server 30 may be constituted by one or more virtual servers in a cloud. For example, the server 30 may be implemented by a system including servers prepared for each of functions, such as one or more servers constructing and managing the virtual space, one or more servers achieving voice chat between avatars (i.e., users) arranged in the virtual space, and one or more servers achieving text chat between avatars arranged in the virtual space.

### Summary of Problems

As described above, proposed herein is volume control in accordance with a distance from a sound source to increase realism of a sound in a virtual space. An object emitting a sound in a virtual space is assumed as the sound source. While discussed in the present embodiment will be an avatar emitting a voice as the sound source, the sound source is not limited to this type of avatar and may include an NPC (Non Player Character) and the like. For example, various types of objects such as an object of a vehicle blaring a siren, an object of an item playing music, or an object of a speaker announcing a message are assumed as the sound source.

FIG. 22 is a diagram explaining volume control of a sound emitted from a different avatar 500b in accordance with a distance between a user avatar 500a and the different avatar 500b. The volume of a sound heard by the user avatar 500a is adjusted in accordance with the distance between the user avatar 500a and the different avatar 500b.

For the volume control, the volume is more reduced as the sound source is located farther (specifically, the attenuation amount of the volume control is raised as the distance from the sound source increases, to achieve distance attenuation). Accordingly, as illustrated in FIG. 22, in a case where the different avatar 500b moves and approaches the user avatar 500a, the speech voice of the different avatar 500b is gradually raised (specifically, the attenuation amount with respect to the volume of the original sound is reduced) to produce realistic sound in a real world.

The position of the different avatar 500b is obtained on the basis of information transmitted from a client terminal corresponding to the different avatar 500b. However, in a case where information transmitted from the client terminal is delayed, a case where a data communication volume is reduced for load reduction, or other cases, the position of the different avatar 500b discretely changes. When the different avatar 500b moves at high speed in a state of a discrete position change, the distance from the different avatar 500b rapidly changes. In this case, the volume of a sound heard by the avatar 500a may rapidly increase and make the user of the avatar 500a uncomfortable.

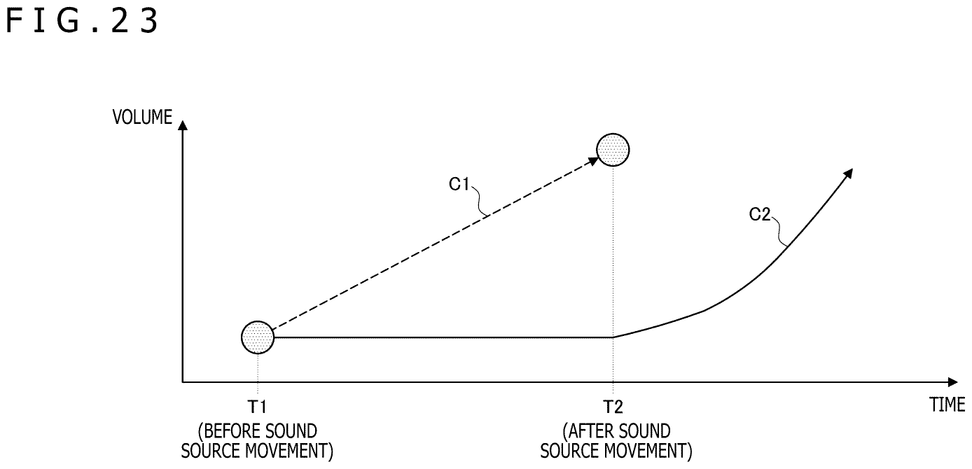

FIG. 23 is a diagram for explaining a comparative example of volume control at the time of a large position change in a short period. FIG. 23 is a graph illustrating a change of a level C of the volume of a sound emitted from the avatar 500b and heard by the avatar 500a. In this graph, the horizontal axis represents time, and the vertical axis represents the volume. The position of the different avatar 500b (sound source position) is confirmed on the basis of information transmitted from the client terminal corresponding to the different avatar 500b (position change information associated with the different avatar 500b or movement operation information associated with the different avatar 500b). As described above, under delay or reduction of the data communication volume, the position of the sound source recognizable on the server side discretely changes. In this case, the avatar 500a may feel uncomfortable if the volume heard by the avatar 500a rapidly increases, as described above. Accordingly, such control which gradually increases the volume from a time T2 (sound source position confirmation time) after movement of the sound source as illustrated in a solid line C1 in FIG. 23 can be adopted.

However, ideal volume control based on realism is such control which gradually increases the volume in a period from a time T1 before movement of the sound source to the time T2 after movement of the sound source as indicated by a dotted line C1 in FIG. 23. The volume control indicated by the solid line C2 starts from the time T2 after movement of the sound source, so that the volume change does not coincide with from the position change of the position of the avatar 500b, and a sense of realism is therefore insufficient.

In view of the above circumstances, the volume control system of the present embodiment predicts a position change of the sound source and starts volume control of the sound source before the position of the sound source is confirmed, making it possible to realize realistic sound.

Hereinafter sequentially discussed will be a configuration of the server 30 implementing the volume control system according to the present embodiment described above and an operation process performed by the server 30.

### <Configuration>

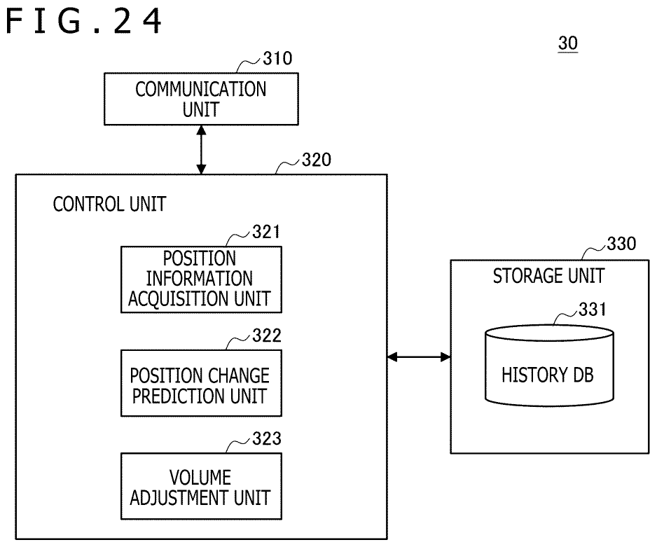

FIG. 24 is a block diagram illustrating an example of the configuration of the server 30 according to the present embodiment. As illustrated in FIG. 24, the server 30 includes a communication unit 310, a control unit 320, and a storage unit 330.

### (Communication Unit 310)

The communication unit 310 includes a transmission unit for transmitting data to an external device and a reception unit for receiving data from an external device. For example, the communication unit 310 according to the present embodiment may be communicably connected with an external device or the Internet by using a wired or wireless LAN (Local Area Network), Wi-Fi (registered trademark), Bluetooth (registered trademark), a portable communication network (LTE (Long Term Evolution), 4G (fourth generation mobile communication system), 5G (fifth generation mobile communication system)), or the like.

### (Control Unit 320)

The control unit 320 functions as an arithmetic processing device and a control device, and controls the overall operations in the server 20 under various types of programs. For example, the control unit 320 is implemented by a CPU (Central Processing Unit), a GPU (Graphics Processing Unit), or an electronic circuit such as a microprocessor. Moreover, the control unit 320 may include a ROM (Read Only Memory) for storing a program to be used, operation parameters, and the like and a RAM (Random Access Memory) for temporarily storing parameters variable as appropriate and the like.

The control unit 320 according to the present embodiment can also function as a position information acquisition unit 321, a position change prediction unit 322, and a volume adjustment unit 323.

The position information acquisition unit 321 acquires position information associated with avatars in the virtual space. According to the present embodiment, an avatar is employed as an example of a sound source. Accordingly, position information associated with an avatar emitting a sound can also be considered as sound source position information. Moreover, position information associated with an avatar hearing a sound can also be considered as hearing position information.

The position change prediction unit 322 predicts a position change of avatars on the basis of position information associated with avatars. For example, non-linear prediction based on an acceleration vector of a sound source may be used as an example of a prediction method of the position change. The position change prediction unit 322 calculates a relative acceleration vector of a sound source position (position of the avatar 500b, for example) as viewed from a hearing position (position of the avatar 500a, for example), on the basis of position information associated with avatars, and stores the calculated relative acceleration vector in a history DB (database) 331 of the storage unit 330. Calculation and storage of the relative acceleration vector are continuously carried out. In response to reception of sound data of the avatar 500b, the position change prediction unit 322 extracts a necessary history of the relative acceleration vector of the avatar 500b from the history DB 331, and predicts a position change (a position change from the current time to a predetermined time) of the avatar 500b. Note that the prediction method of the position change according to the present embodiment is not limited to the foregoing prediction method and may be other appropriate prediction methods. For example, linear prediction may be adopted instead of non-linear prediction using an acceleration vector.

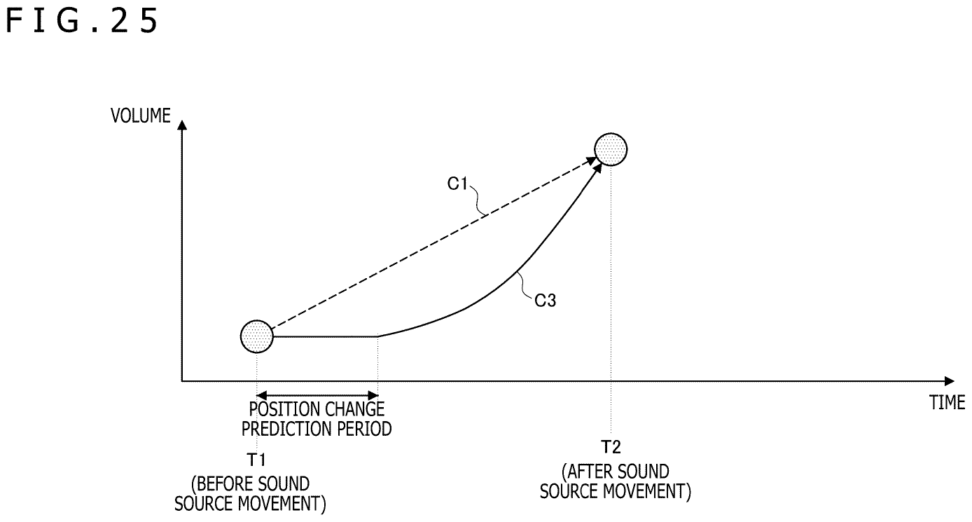

The volume adjustment unit 323 adjusts the volume of sound data of the avatar 500b in accordance with a position change predicted by the position change prediction unit 322. Specifically, this volume adjustment is achieved by distance attenuation which reduces the volume in accordance with a distance between the avatar 500b and the avatar 500a. This volume adjustment can be started at a time point corresponding to output of a prediction result of a position change and before confirmation of a sound source position (before confirmation of the position of the avatar 500b based on received information). More details will be discussed with reference to FIG. 25.

FIG. 25 is a diagram for explaining volume control performed in accordance with a predicted position change. FIG. 25 is a graph illustrating a change of a level C of the volume of a sound emitted from the avatar 500b and heard by the avatar 500a. In this graph, the horizontal axis represents time, and the vertical axis represents the volume.

According to the present embodiment, the position change prediction unit 322 predicts a position change of the avatar 500b (sound source). The volume adjustment unit 323 starts adjustment of the volume in accordance with a predicted position change after an elapse of a prediction period from the time T1 before movement of the sound source, i.e., immediately after prediction of the position change. For example, the position change prediction unit 322 may predict a position change which will have occurred at a confirmation timing of a subsequent sound source position or predict a position change which will have occurred after an elapse of a fixed time. Moreover, assumed in the example illustrated in FIG. 25 is a case of adjustment which increases the volume (adjustment which reduces the attenuation amount) when the avatar 500b moves in a direction for approaching the avatar 500a, i.e., the distance between the avatar 500a and the avatar 500b decreases.

According to the present embodiment, unlike the volume control illustrated in FIG. 23, the volume control is started before the time T2 after movement of the sound source (sound source position confirmation) as indicated by a solid line C3 in FIG. 25. In this manner, a volume controlled state in accordance with the distance at the time T2 after movement of the sound source can be produced in the present embodiment. Accordingly, problems such as a rapid volume change which may make the user of the avatar 500a uncomfortable and insufficient realism produced by delay of volume control performed after movement of the sound source (avatar 500b) as illustrated in FIG. 23 are avoidable.

### (Storage Unit 330)

The storage unit 330 is implemented by a ROM which stores a program, operation parameters, and the like used by the control unit 320 for processing and a RAM which temporarily stores parameters appropriately variable and the like.

While the specific configuration of the server 30 has been described above, the configuration of the server 30 according to the present disclosure is not limited to the example illustrated in FIG. 24. For example, the server 30 is not necessarily required to have all of the components illustrated in FIG. 24. Moreover, the server 30 may be implemented by a system including a plurality of devices.

### <Operation Process>

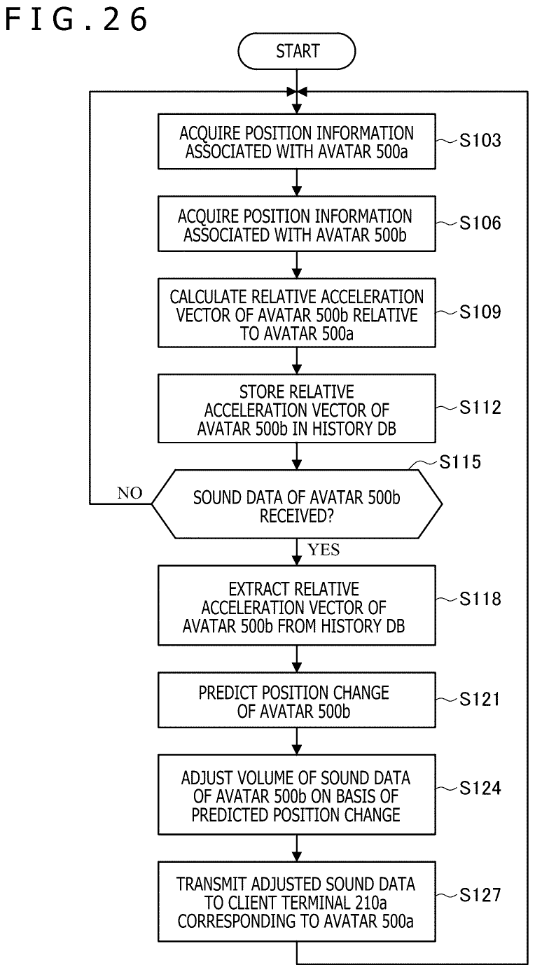

FIG. 26 is a flowchart illustrating an example of a flow of volume control according to the present embodiment. Discussed herein will be volume control of a sound of the avatar 500b in a case where a sound source and a hearing person are the avatar 500b and the avatar 500a, respectively.

As illustrated in FIG. 26, the server 30 first acquires position information associated with the avatar 500a and position information associated with the avatar 500b (steps S103 and S106).

Subsequently, the server 30 calculates a relative acceleration vector of the avatar 500b relative to the avatar 500a on the basis of the acquired position information (step S109).

Subsequently, the server 30 stores the relative acceleration vector of the avatar 500b in the history DB 331 (step S112).

Thereafter, in response to reception of sound data of the avatar 500b (step S115: Yes), the server 30 extracts the relative acceleration vector of the avatar 500b from the history DB 331 (step S118), and predicts a position change of the avatar 500b (step S121). For example, the prediction of the position change may be prediction of a position change after an elapse of a fixed time or subsequent timing of confirmation of the position of the avatar 500b (sound source position) (subsequent reception timing of information for sound source position confirmation from the client terminal 210b corresponding to the avatar 500b).

Subsequently, the server 30 adjusts the volume of sound data of the avatar 500b on the basis of the predicted position change (step S124). Specifically, the server 30 carries out distance attenuation for the volume of the sound data of the avatar 500b. The adjustment of the volume achieved by the server 30 can be started before subsequent confirmation of the position of the avatar 500b (sound source position). For example, even in a case where the position discretely changes due to long intervals of the position confirmation of the avatar 500b, volume adjustment of the sound of the avatar 500b can be started before position confirmation on the basis of prediction of the position change beforehand. In this manner, the volume change capable of following movement of the avatar 500b (sound source) is achievable. Accordingly, experimental values of the virtual space can be enhanced with realistic sound thus produced.

The server 30 transmits the adjusted sound data to the client terminal 210a corresponding to the avatar 500a (step S127). Note that the sound data (sound stream) of the avatar 500b is transmitted from the client terminal 210b corresponding to the avatar 500b to the client terminal 210a corresponding to the avatar 500a via the server 30. The server 30 carries out volume adjustment corresponding to the predicted position change for the sound stream received from the client terminal 210b, and then transmits the adjusted sound stream to the client terminal 210a.

The operation process discussed above may be performed during login to the virtual space (connection with the server 30) by the client terminal 210a and the client terminal 210b, or during voice chat between at least the avatar 500a (a user A) and the avatar 500b (a user B) (in other words, in a state where a group allowed to have voice conversation is formed).

Processing performed in steps S103 to S112 described above can continuously be repeated during processing in steps S118 to S127 described above.

The server 30 can perform the operation process described above for each of avatars acting in the virtual space. Moreover, in a case where the group allowed to have voice conversation is constituted by a plurality of avatars, the server 30 may acquire position information associated with avatars belonging to this group, and predict position changes of the respective avatars on the basis of a history of the position information (or a history of acceleration vectors). The server 30 can start volume adjustment of a stream sound corresponding to a sound source (an avatar emitting a sound in the group) in accordance with the predicted position changes before position confirmation of this sound source.

### <Modifications>

### (Modification 1)

A position of an avatar corresponding to a sound source is confirmed on the basis of information transmitted from the client terminal 210 corresponding to this avatar to the server 30. The information transmitted from the client terminal 210 may be position information indicating position coordinates of the avatar in the virtual space, or position change information indicating a movement amount (including a direction) from a previous position. Discussed will hereinafter be an example where position information is transmitted from the client terminal 210.

The server 30 predicts a position change of an avatar on the basis of position information received from the client terminal 210. However, in a case where reception of position information is delayed due to a delay on a network (what is generally called network latency), prediction accuracy of the position change may be lowered.

In view of the above circumstances, modification 1 proposed herein increases prediction accuracy by correcting deviation of position information reception timing before prediction of a position change.

Specifically, deviation of position information reception timing can be corrected by fixing intervals of transmission of position information from the client terminal 210 and enabling the server 30 to recognize transmission time.

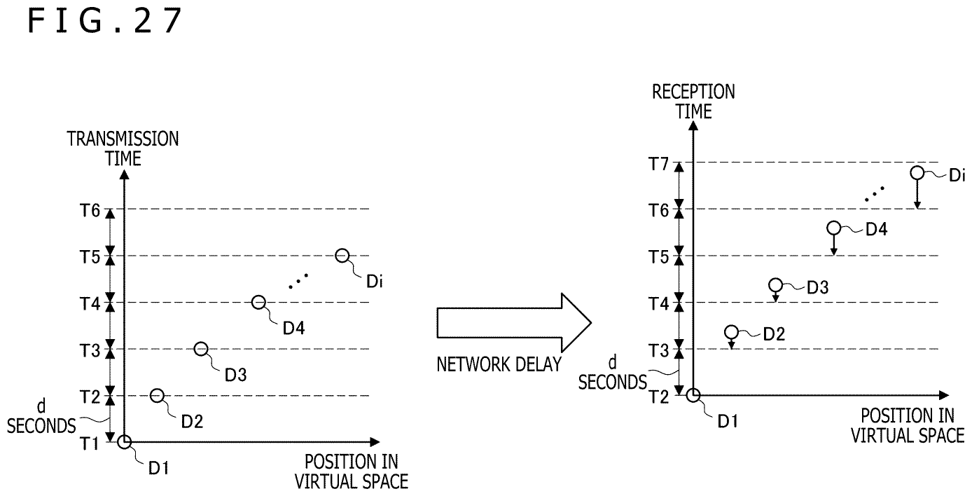

FIG. 27 is a diagram for explaining correction of deviation of position information reception timing. As illustrated in a left part in FIG. 27, position information D (D1 to Di) is transmitted from the client terminal 210 at predetermined time intervals (intervals of d seconds, for example). Note that the horizontal axis in FIG. 27 represents a position in the virtual space. It is assumed herein by way of example that the avatar 500b corresponding to a sound source moves in one direction toward the avatar 500a located on the hearing side.

Subsequently, the server 30 configured to receive the position information D transmitted from the client terminal 210 receives the position information D as illustrated in a right part in FIG. 27. The position information D is received at predetermined time intervals (intervals of d seconds, for example) in a normal condition. However, in a case of a network delay, deviation of reception timing can be produced as illustrated in the right part in FIG. 27.

In a case of deviation of reception timing, the server 30 corrects the reception timing of position information to an original time of reception (dxi seconds). For example, each reception time of the position information D2 to Di is corrected in the figure illustrated in the right part in FIG. 27.

Subsequently, the server 30 can calculate an acceleration vector on the basis of position information including the corrected reception time, and predict a position change. Deterioration of prediction accuracy is avoidable by correcting deviation of the reception timing.

### (Modification 2)

The server 30 may measure a delay state of the network on the basis of deviation of reception timing of position information received from the client terminal 210, which is the deviation described in modification 1, and give a notification that the current communication environment is a low-quality environment in accordance with a measurement value by using a display mode of a target avatar.

For example, in a case where deviation of reception timing of position information from the avatar 500b exceeds a threshold, the server 30 changes a display mode of the avatar 500b to give a notification that the communication environment of the avatar 500b is in a low-quality state. In this manner, discomfort caused by, for example, an unnatural behavior of the avatar 500b as a result of a network delay can be eliminated.

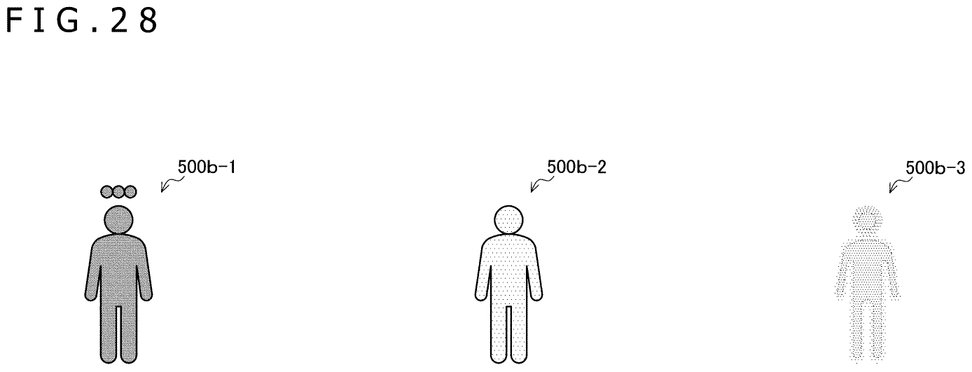

FIG. 28 is a diagram illustrating an example of a change of an avatar display mode for clearly indicating low quality of a communication environment.

An example of an avatar 500b-1 illustrated in a left part in FIG. 28 is an example of a display mode where a count icon is displayed above the head according to a decrease in quality of the communication environment. For example, the count icon may indicate up to three circles. A larger count number indicates lower quality. An example of an avatar 500b-2 illustrated in a center part in FIG. 28 is an example of a display mode where color contrast is adjusted according to a decrease in quality of the communication environment. A lighter color indicates lower quality. An example of an avatar 500b-3 illustrated in a right part in FIG. 28 is an example of a display mode where a blur effect is added according to a decrease in quality of the communication environment. A higher degree of blurring indicates low quality.

### <Supplementary Notes>

The volume adjustment unit 323 described above may be included in the client terminal 210. Specifically, the client terminal 210 may adjust the volume in accordance with a position change predicted by the server 30, at the time of output of sound data received via the server 30.

Moreover, the position change prediction unit 322 and the volume adjustment unit 323 described above may be included in the client terminal 210. Specifically, the client terminal 210 may predict a position change of a sound source, and adjust the volume of sound data that is received via the server 30 and that corresponds to the sound source, in accordance with the predicted position change.

Moreover, the volume control system 2 according to the present embodiment may be implemented by the system configuration illustrated in FIG. 2 or 4. This system configuration includes transfer servers (SFUs: Selective Forwarding Units, for example) provided in respective clusters each constituted by a plurality of the client terminals 210, and also includes a domain controller (the server 30) provided as an information processing device in a layer higher than the transfer servers. Each of the transfer servers and the domain controller can include a server in a cloud service. Up to the 50 client terminals 210 may be connected to a corresponding one of the transfer servers. Moreover, up to 50 clusters may be provided in the network system.

According to the volume control system 2 of the present embodiment described above, a plurality of avatars added as friends (client terminals 210) have voice conversation in a group constituted by these avatars, for example. This group is assumed to be formed in the same cluster.

Moreover, when the system configuration illustrated in FIG. 2 or 4 is adopted as the system configuration of the volume control system 2 of the present embodiment, “1. Technology for scaling out number of persons simultaneously connected to metaverse virtual space” may be applied. Specifically, pieces of data (streams) transmitted from the respective client terminals 210 to the transfer server (the SFU, for example) are combined into one stream by the transfer server. In a case where one cluster is constituted by 50 clients, 50 streams are combined into one stream, and transmitted from the transfer server to the domain controller. This configuration can achieve more traffic reduction than in a case where 50 streams transmitted from the respective client terminals 210 are transferred to the domain controller via the transfer server without change.

Further, the volume control system 2 according to the present embodiment may be implemented by the system configuration illustrated in FIG. 19. In this case, the function of the server 30 can be implemented by the Domain Controllers 11 (11-1 to 11-3), for example.

In addition, the server 30 may be implemented by the hardware configuration illustrated in FIG. 20.

Further, while described above is volume adjustment by the volume control system 2 according to the present embodiment at the time of voice conversation in a group constituted by a plurality of avatars added as friends (client terminals 210), for example, sound data corresponding to a volume adjustment target is not limited to conversation in the group. For example, also assumed is such a case where avatars not forming a group are allowed to have voice conversation with each other (e.g., a case of control based on avatar positions such that sound data from a sound source located within a predetermined hearable range can be heard). The volume control technology according to the present embodiment is also applicable to volume adjustment of sound data in this voice conversation.

Moreover, in a case where a plurality of clusters are formed according to areas in the virtual space, movement of a sound source (avatar, for example) corresponding to a target of volume control of the volume control system 2 according to the present embodiment is not limited to movement in the same cluster (e.g., movement in an area 1), and may be movement to a different cluster (e.g., movement from the area 1 to an area 2). For example, also in a case where an avatar operated by the user of the client terminal 210 included in a first cluster managed by a first SFU moves from the area 1 corresponding to the first cluster to the area 2 corresponding to the second cluster 2 managed by a second SFU, a position change can be predicted by the server 30, and volume control corresponding to the predicted position change can be started before position confirmation.

### 7. Environmental Sound Providing Technology in Virtual Space

### <Outline>

Described will be an environmental sound providing technology in a virtual space according to an embodiment of the present disclosure. In a virtual space where a large number of avatars are active, not only voices of avatars having conversation by voice chat but also a crowd sound such as noise in the whole venue is provided to increase realism.

For example, a crowd sound can be created beforehand and provided. In this case, however, a sound emitted in real time in the virtual space is difficult to handle. For example, in a case where one person of an audience sends a cheer in a loud voice in a venue of a virtual space or a case where a voice for attracting attention of customers is suddenly given at a start of a limited time sale in an exhibition and sale, these types of sounds are difficult to handle with use of a crowd sound prepared beforehand.

In view of the above circumstances, an environmental sound is created from a current sound emitted in the virtual space, to achieve realism of the virtual space.

### Summary of Problems

Assume herein that such a sound as conversation with a different avatar is provided via a track different from that of an environmental sound in a state where an environmental sound is created and provided in real time with use of all sounds emitted in the virtual space. In this case, there is a possibility that voices of conversation with the different avatar are not synchronized and heard as a double sound or that a self-voice is heard with echoes, for example.

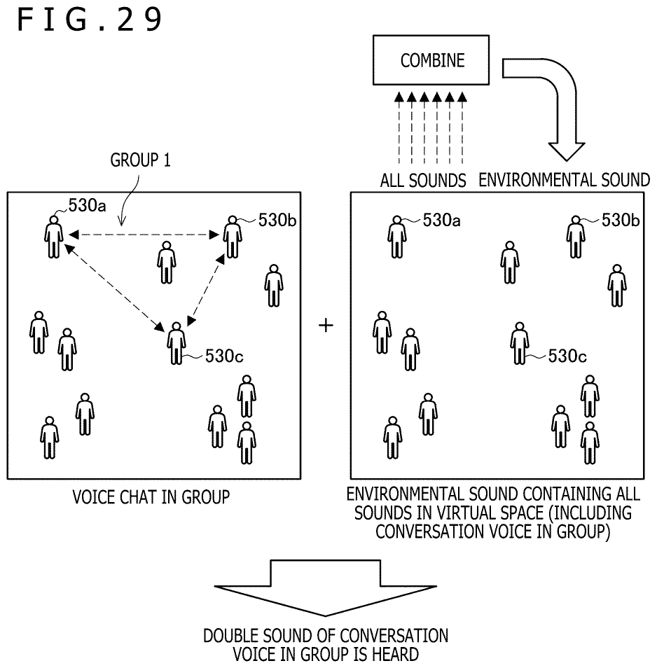

FIG. 29 is a diagram for explaining a case where a conversation voice is contained in an environmental sound and heard as a double sound. For example, in a case where all sounds emitted in the virtual space are combined into an environmental sound and provided for avatars 530a, 530b, and 530c in a group 1 constituted by the avatars 530a, 530b, and 530c in the virtual space, as illustrated in a right part in FIG. 29, during voice chat in the group 1 as illustrated in a left part in FIG. 29, a conversation voice in the group 1 is heard as a double sound by the members of the group 1.

For dealing with this problem, a sound in the group can be excluded from the environmental sound, for example. In this case, however, sufficient realism of a real venue cannot be considered to be reproduced in a case where an exciting state of voice chat in each of a plurality of groups in the virtual space is not heard as an environmental sound.

Alternatively, supply of an environmental sound to users having voice chat in the group can be prohibited. In this case, however, noise or an exciting state in a venue cannot be sensed, and a voice for attracting attention of customers in an exhibition and sale or other sounds cannot be noticed.

In view of the above circumstances, the environmental sound providing system according to the present embodiment removes a sound of the user from an environmental sound created in real time on the basis of a sound emitted in the virtual space, making it possible to eliminate a self-sound heard by the user and improve realism of the virtual space. Moreover, the environmental sound providing system according to the present embodiment removes a conversation voice of a group having voice chat from an environmental sound created in real time on the basis of a sound containing the conversation voice in the group in the virtual space and provides the resultant conversation voice for users belonging to the group, making it possible to eliminate a conversation voice heard as a double sound in the group, for example, and improve realism of the virtual space.

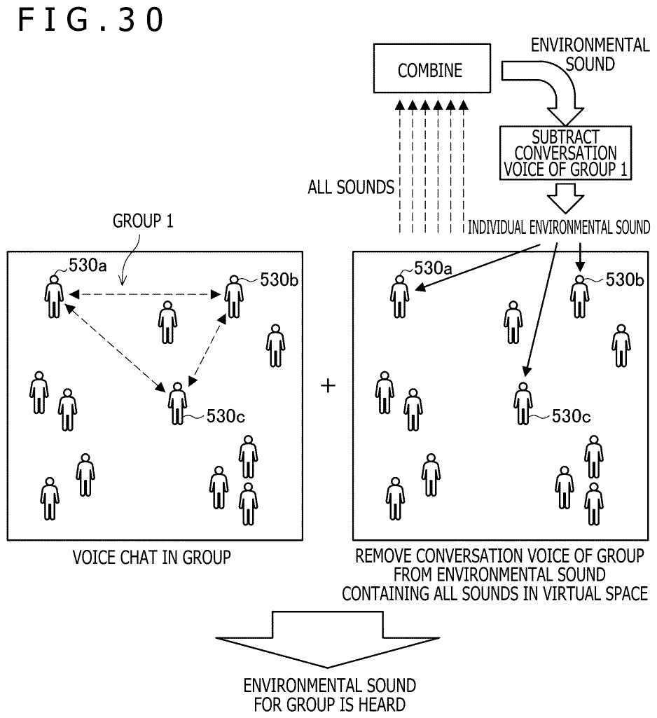

FIG. 30 is a diagram for explaining an outline of the environmental sound providing system according to the present embodiment. For example, during voice chat in the group 1 constituted by the avatars 530a, 530b, and 530c in the virtual space as illustrated in a left part in FIG. 30, components of a conversation voice in the group 1 are subtracted from an environmental sound created by combining all voices emitted in the virtual space, to create an individual environmental sound as illustrated in a right part in FIG. 30. The above-described individual environmental sound is provided for the avatars 530a, 530b, and 530c of the group 1 as an environmental sound dedicated for the group 1. Accordingly, a surrounding sound can be provided as an environmental sound while a conversation voice of the group 1 heard as a double sound is eliminated, and therefore, realism of the virtual space is achievable.

A configuration of the environmental sound providing system according to the present embodiment as described above will hereinafter be specifically described.

### <System Configuration>

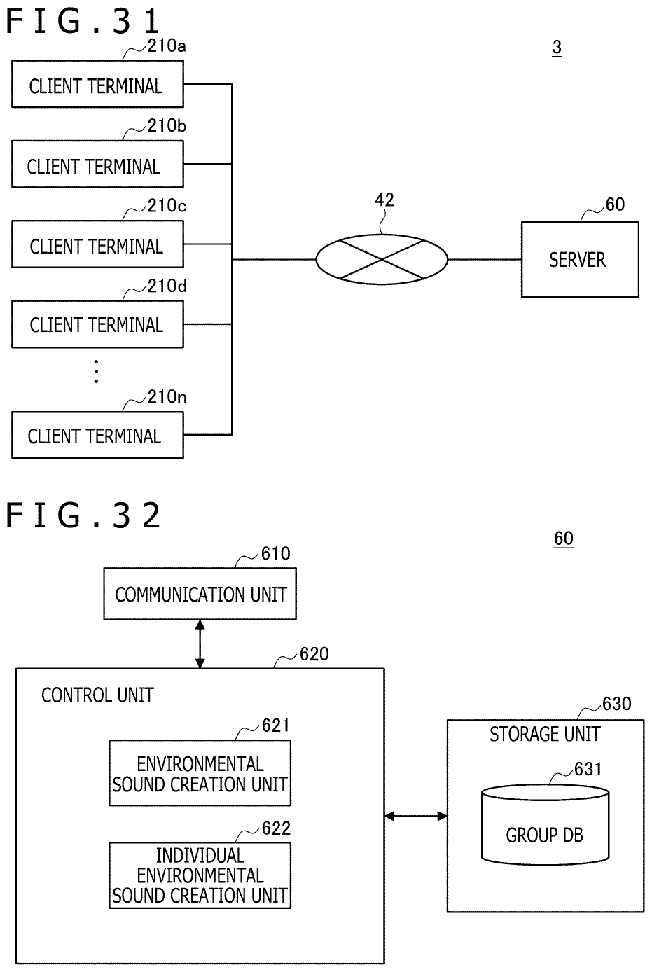

FIG. 31 is a diagram illustrating an example of a configuration of an environmental sound providing system according to an embodiment of the present disclosure. As illustrated in FIG. 31, an environmental sound providing system 3 includes a server 60 and client terminals 210 (210a to 210n) used to operate avatars. The client terminals 210 and the server 60 can be connected to each other via a network 42.

### (Client Terminal 210)

The client terminals 210 are configured as explained with reference to FIG. 21. Moreover, the client terminals 210 can display video representing a virtual space from a viewpoint of the user, on the basis of information received from the server 60.

### (Server 60)

The server 60 has a function of creating a virtual space and providing information associated with the virtual space for the client terminals 210. For example, the server 60 transmits information necessary for drawing the virtual space (map information, information associated with various types of objects, etc.) to the client terminals 210 logging in (connecting with) the virtual space, and continuously transmits update information associated with the virtual space (for example, position information associated with different avatars, motion information, etc.) during connection. The server 60 performs control for synchronizing pieces of information associated with the virtual space and handled by the plurality of client terminals 210 to enable a plurality of users to share the virtual space.

The server 60 may generate information for each of video and sounds in the virtual space in accordance with positions of avatars corresponding to the respective client terminals 210 in the virtual space, and transmit the generated information to a corresponding one of the client terminals 210. Rendering of video and sounds may be achieved either by the server 60 or by the client terminals 210.

The server 60 may be a system including a plurality of servers. Moreover, the server 60 may be constituted by one or more virtual servers in a cloud. For example, the server 60 may be implemented by a system including servers prepared for each of functions, such as one or more servers constructing and managing the virtual space, one or more servers achieving voice chat between avatars (i.e., users) arranged in the virtual space, and one or more servers achieving text chat between avatars arranged in the virtual space.

### <Configuration of Server 60>

FIG. 32 is a block diagram illustrating an example of a configuration of the server 60 according to the present embodiment. As illustrated in FIG. 32, the server 60 includes a communication unit 610, a control unit 620, and a storage unit 630.

### (Communication Unit 610)

The communication unit 610 includes a transmission unit for transmitting data to an external device and a reception unit for receiving data from an external device. For example, the communication unit 610 according to the present embodiment may be communicably connected with an external device or the Internet by using a wired or wireless LAN (Local Area Network), Wi-Fi (registered trademark), Bluetooth (registered trademark), a portable communication network (LTE (Long Term Evolution), 4G (fourth generation mobile communication system), 5G (fifth generation mobile communication system)), or the like.

### (Control Unit 620)

The control unit 620 functions as an arithmetic processing device and a control device, and controls the overall operations in the server 60 under various types of programs. For example, the control unit 620 is implemented by a CPU (Central Processing Unit), a GPU (Graphics Processing Unit), or an electronic circuit such as a microprocessor. Moreover, the control unit 620 may include a ROM (Read Only Memory) for storing a program to be used, operation parameters, and the like and a RAM (Random Access Memory) for temporarily storing parameters variable as appropriate and the like.

The control unit 620 according to the present embodiment can also function as an environmental sound creation unit 621 and an individual environmental sound creation unit 622.

The environmental sound creation unit 621 combines pieces of sound data in the virtual space to create an environmental sound. The created environmental sound is provided for users corresponding to respective avatars in the virtual space. Specifically, the created environmental sound is reproduced by the client terminals 210 corresponding to the respective avatars. The environmental sound creation unit 621 is capable of achieving realism of the virtual space by creating an environmental sound on the basis of real-time sound data and providing the created environmental sound. Moreover, the environmental sound creation unit 621 may attenuate an environmental sound before providing this environmental sound for the users. Specifically, an excessively large volume of an environmental sound may make the users uncomfortable. Accordingly, an environmental sound may be attenuated to a level of noise of the whole virtual space.

In a case where an environmental sound created by the environmental sound creation unit 621 contains conversation voices of groups, the individual environmental sound creation unit 622 creates an individual environmental sound by subtracting the group conversation voice from the environmental sound for each group. An individual environmental sound created by subtracting a group conversation voice is provided for a group having voice chat.

### (Storage Unit 630)

The storage unit 630 is implemented by a ROM which stores a program, operation parameters, and the like used by the control unit 620 for processing and a RAM which temporarily stores parameters appropriately variable and the like.

While the specific configuration of the server 60 has been described above, the configuration of the server 60 according to the present disclosure is not limited to the example illustrated in FIG. 32. For example, the server 60 is not necessarily required to have all of the components illustrated in FIG. 32. Moreover, the server 60 may be implemented by a system including a plurality of devices.

### <Details of Provision of Environmental Sound>

Subsequently, details of provision of an environmental sound according to the present embodiment will be described with reference to the drawings.

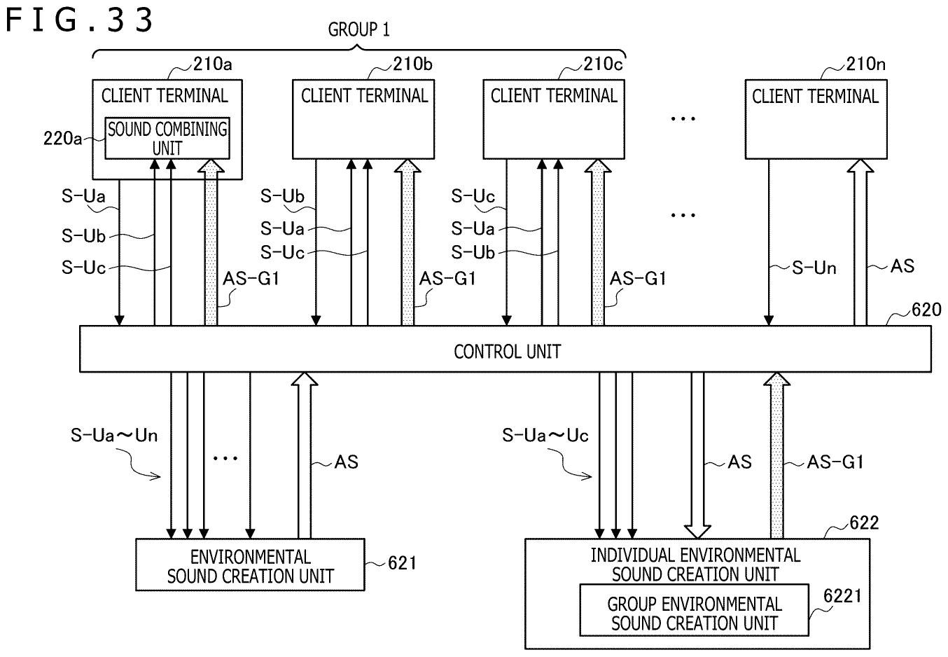

FIG. 33 is a diagram explaining details of provision of environmental sounds. First, the client terminals 210a to 210n transmit user sounds S-Ua to S-Un to the server 60 in real time, respectively. Each of the user sounds S-Ua to S-Un is not limited to a conversation voice in a group.

The control unit 620 of the server 60 inputs the user sounds S-Ua to S-Un to the environmental sound creation unit 621. The environmental sound creation unit 621 combines the user sounds S-Ua to S-Un, i.e., all user sounds in the virtual space, and outputs the resultant sound as an environmental sound AS. Note that the environmental sound creation unit 621 may output the environmental sound AS obtained by attenuation.

Subsequently, in a case where the sound used for creation of the environmental sound AS contains a conversation voice in the group, the control unit 620 inputs the environmental sound AS and the conversation voice in the group to the individual environmental sound creation unit 622. According to the example illustrated in FIG. 33, the client terminals 210a to 210c constitute the group 1, and the user sound S-Ua to S-Uc corresponds to a conversation voice.

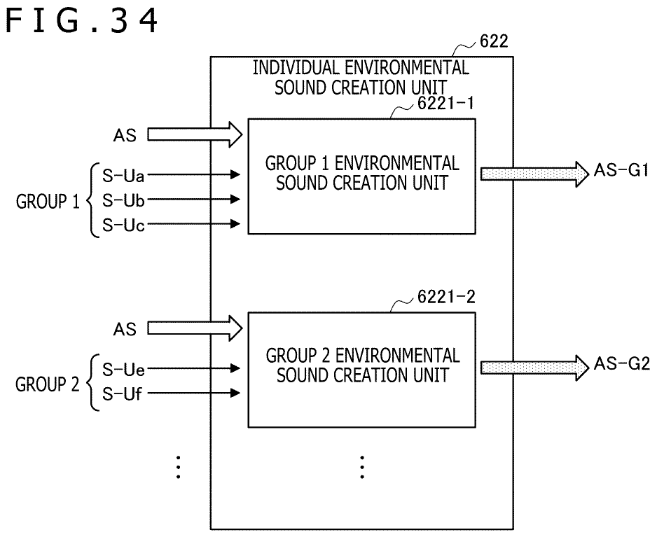

The individual environmental sound creation unit 622 has a function of a group environmental sound creation unit 6221 for creating a group environmental sound for each group as an individual environmental sound. FIG. 34 is a diagram for explaining details of the group environmental sound creation unit 6221. As illustrated in FIG. 34, the group environmental sound creation unit 6221 can be prepared for each group. For example, a group 1 environmental sound creation unit 6221-1 for the group 1 subtracts components of the user sounds S-Ua to S-Uc from the environmental sound AS on the basis of the environmental sound AS and the user sounds S-Ua to S-Uc corresponding to a conversation voice of the group 1 to create and output a group 1 individual environmental sound AS-G1. Moreover, for example, a group 2 environmental sound creation unit 6221-2 for the group 2 subtracts components of the user sounds S-Ue to S-Uf from the environmental sound AS on the basis of the environmental sound AS and the user sounds S-Ue to S-Uf corresponding to a conversation voice of the group 2 to create and output a group 2 individual environmental sound AS-G2.

Discussed herein by way of example again with reference to FIG. 33 will be the group 1 individual environmental sound AS-G1 output from the individual environmental sound creation unit 622. The control unit 620 transmits the group 1 individual environmental sound AS-G1 to each of the client terminals 210a to 210c constituting the group 1. Moreover, the control unit 620 also transmits conversation voices of the different users in the group 1 to the client terminals 210a to 210c. Specifically, the control unit 620 transmits the user sounds S-Ub and S-Uc to the client terminal 210a, transmits the user sounds S-Ua and S-Uc to the client terminal 210b, and transmits the user sounds S-Ua and S-Ub to the client terminal 210c.

Each of the client terminals 210 includes a sound combining unit 220. Sounds received via a different track are combined by the sound combining unit 220, and the resultant sound is provided for the users. For example, a sound combining unit 220a of the client terminal 210a combines the user sounds S-Ub and S-Uc and the group 1 individual environmental sound AS-G1, and provides the resultant sound.

As described above, the group 1 individual environmental sound AS-G1 is an environmental sound created by subtracting a conversation voice of the group 1 from the environmental sound AS. In this case, a conversation voice of the group 1 is not heard as a double sound even when the group 1 individual environmental sound AS-G1 and the conversation voice are combined and the resultant sound is provided by the client terminal 210a. Accordingly, a user a of the client terminal 210a can clearly hear the conversation voice of the group 1 and also hear a real-time environmental sound in the virtual space, and can therefore enjoy a sense of realism.

Note that the control unit 620 of the server 60 transmits the environmental sound AS to the client terminal 210n not belonging to the group.

### <Operation Process>

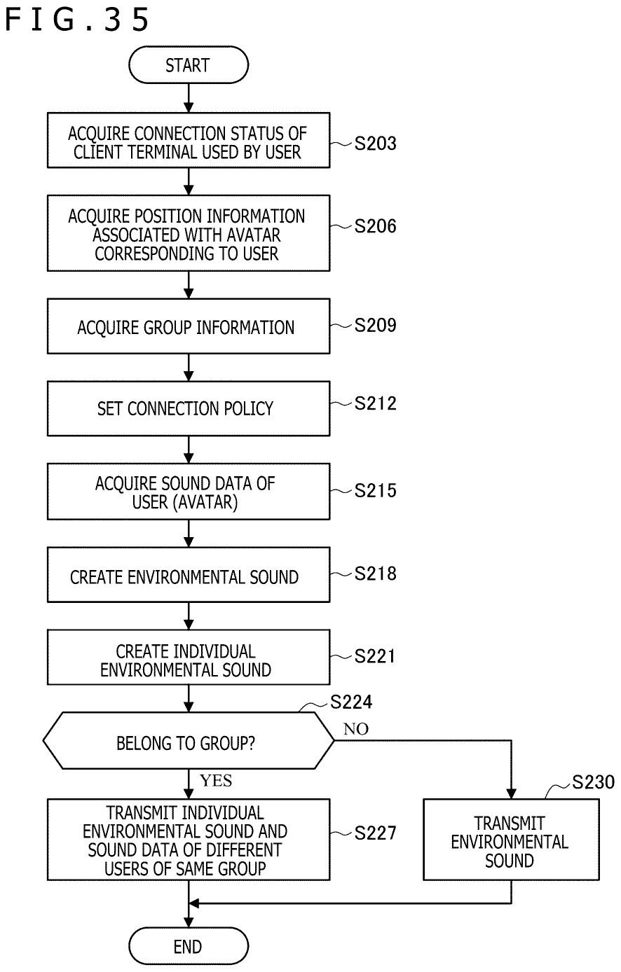

FIG. 35 is a flowchart illustrating an example of an operation process performed by the environmental sound providing system according to the present embodiment.

As illustrated in FIG. 35, the server 60 first acquires a connection status between the client terminals 210 used by users and the server 60 (step S203). Specifically, the server 60 checks users logging in to the virtual space.

Subsequently, the server 60 acquires position information associated with avatars corresponding to the respective users logging in to the virtual space (step S206).

Subsequently, the server 60 acquires group information associated with a group constituted by a plurality of avatars (step S209). The users can constitute a group for voice chat allowing the users to hear clear voices, for example, in the virtual space.

Subsequently, the server 60 sets a policy for connection between the users (step S212). Specifically, the server 60 sets a “manner of transmission” between the individual users as a connection policy on the basis of position information associated with the avatars corresponding to the respective users in the virtual space and the group information in accordance with a set of policies indicating a manner of transmission of sound data between each pair of the users. For example, the following policy is included in the set of policies. A sound in the virtual space is supplied as an environmental sound. In this case, an individual environmental sound from which a conversation voice in the group has been removed is supplied to the users belonging to the group. Moreover, the following policy is included, for example. The virtual space is divided into a plurality of areas. A sound in an area containing avatars is supplied as stereoscopic sound, but a sound outside this area is supplied as an environmental sound. Further, the following policy is also included, for example. An announcement voice in a venue is provided for all avatars (excluding the user giving this announcement) without distance attenuation.

Subsequently, the server 60 acquires sound data of the users (avatars) from the client terminals 210 (step S215).

Thereafter, the server 60 combines the pieces of sound data of the respective users in the virtual space to create an environmental sound (step S218).

In a case where the environmental sound contains a conversation voice in the group, the server 60 then subtracts the conversation voice from the environmental sound to create an individual environmental sound for the group (step S221).

Subsequently, the server 60 performs output control of sound data in accordance with the connection policy set for each of the users. Discussed herein will be such an example which supplies an individual environmental sound to the users belonging to the group and supplies an environmental sound to the users not belonging to the group. Note that the connection policy can be updated as necessary.

In a case where the users belong to the group (step S224: Yes), the server 60 transmits an individual environmental sound and sound data of the different users of the group to these users (step S227).

Meanwhile, in a case where the users do not belong to the group (step S224: No), the server 60 transmits an environmental sound to these users (step S230).

Discussed above has been an example of the operation process according to the present embodiment.

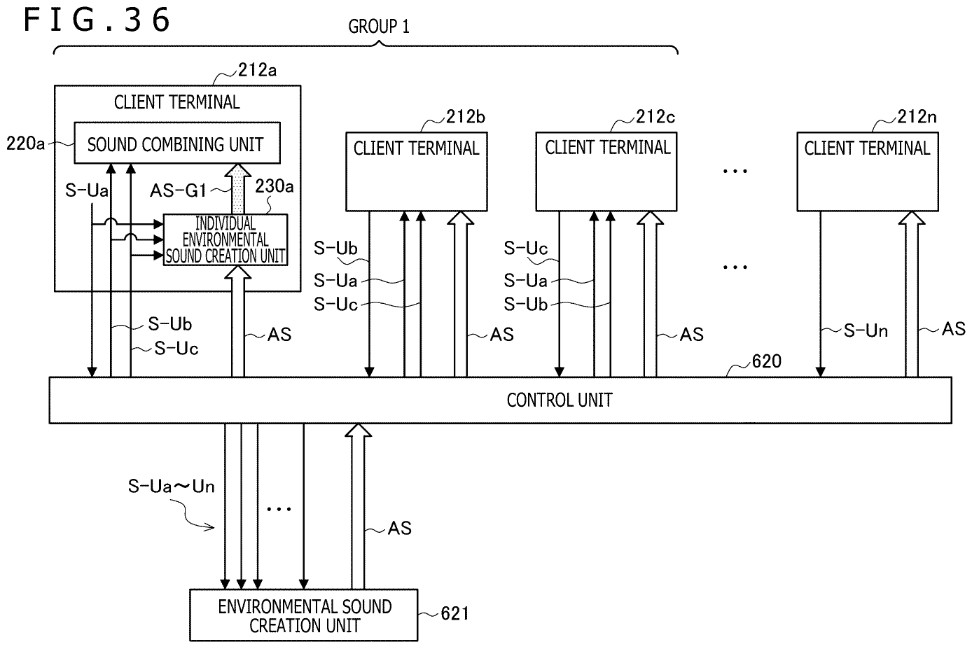

Note that an individual environmental sound may be created by the client terminals instead of the server 60. FIG. 36 is a diagram for explaining a case where individual environmental sounds are created by client terminals 212.

As illustrated in FIG. 36, when the environmental sound creation unit 621 of the server 60 combines the user sounds S-Ua to S-Un, i.e., all user sounds in the virtual space, and outputs the resultant sound as the environmental sound AS, the control unit 620 of the server 60 transmits the environmental sound AS to the client terminals 212a to 212n.

Each of the client terminals 212 has an individual environmental sound creation unit 230. For example, the client terminal 212a constituting the group 1 subtracts a conversation voice in the group (specifically, user sounds S-Ua to S-Uc) from the environmental sound AS to create the group 1 individual environmental sound AS-G1 by using an individual environmental sound creation unit 230a, and outputs the group 1 individual environmental sound AS-G1. Thereafter, the client terminal 212a combines the user sounds S-Ub and S-Uc and the group 1 individual environmental sound AS-G1 by using the sound combining unit 220a, and provides the resultant sound for the user.

The group 1 individual environmental sound AS-G1 can be created by each of the client terminals 212a to 212c belonging to the group 1.

### <Modifications>

Modifications of the present embodiment will be subsequently described.

### (Modification 1)

According to the embodiment described above, sound data in the virtual space is combined to create an environmental sound. However, the environmental sound created in the present disclosure is not limited to this type of sound, and may be a sound created in the following manner. Specifically, the virtual space is divided into a plurality of areas, and a cluster environmental sound is created for each of clusters corresponding to the respective areas. Thereafter, the cluster environmental sounds of the respective clusters are combined into a whole environmental sound corresponding to an environmental sound of the whole virtual space. The manner of division into the areas is not particularly limited. For example, the region of the virtual space may be divided into equal parts.

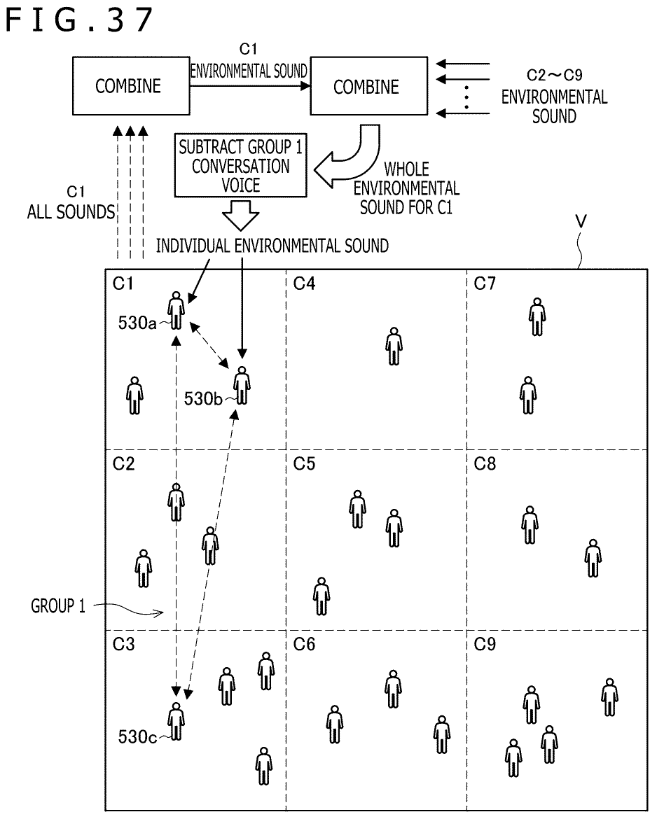

FIG. 37 is a diagram explaining creation of an environmental sound for each cluster according to modification 1. According to the example illustrated in FIG. 37, a virtual space V is divided into nine clusters (areas) C1 to C9. To which cluster each of avatars belongs is determined in accordance with the position of the corresponding avatar. Moreover, each of the avatars and other avatars can constitute a group where clear voice chat is realizable regardless of the positions of the respective avatars in the virtual space V. According to the example illustrated in FIG. 37, the avatars 530a and 530b located in the cluster C1 and the avatar 530c located in the cluster C3 constitute the group 1, and have voice conversation in the group. Hereinafter discussed will be creation of an environmental sound for each cluster in such a situation according to modification 1.

The server 60 combines all sounds in the cluster C1 to create a cluster 1 environmental sound. Moreover, the server 60 creates a cluster n environmental sound for each of different clusters n in a similar manner.

Subsequently, the server 60 combines all cluster environmental sounds (cluster 1 to 9 environmental sounds in the example illustrated in FIG. 37) to create an environmental sound of the whole virtual space (hereinafter referred to as a whole environmental sound). The server 60 may create the whole environmental sound by combining the cluster environmental sounds obtained by distance attenuation carried out for each cluster in accordance with distances from the different clusters. The position of each of the clusters is set to a center position of the corresponding cluster (area). For example, for creating a whole environmental sound for the cluster C1, the server 60 attenuates a cluster environmental sound of each of the other clusters C2 to C9 in accordance with distances from the cluster C1, and then combines the attenuated cluster environmental sounds of the clusters C1 to C9.

The following equation 1 is a formula for calculating the whole environmental sound described above. In the following equation 1, All AS(i) represents a whole environmental sound for a user located in a cluster i, α(i, x) represents an attenuation coefficient corresponding to a distance between the cluster i and a cluster x, and Cluster AS(x) represents a cluster environmental sound created on the basis of a sound of a user located in the cluster x.

$$[ Math . 1 ]$$

$$All AS ( i ) = \sum [ x = 0 … n ] α ( i , x ) Cluster AS ( x ) \qquad ( Equation 1 )$$

The server 60 may create the whole environmental sound by a stereoscopic process based on not only the distance attenuation but also a relative positional relation between clusters.

For the users located in each of the clusters, the server 60 provides a whole environmental sound specific for the corresponding cluster. In this case, for the users individually exchanging voices with other users, i.e., the users belonging to the group and having voice chat, the server 60 provides an individual environmental sound created by subtracting (i.e., echo-cancelling) an individual sound (i.e., conversation voice in the group) from the whole environmental sound for the cluster.

According to the example illustrated in FIG. 37, an individual environmental sound created by subtracting the group 1 sound from the whole environmental sound for the cluster 1 is provided for the users who are located in the cluster 1 and who belong to the group 1 (specifically, the user a of the avatar 530a and a user b of the avatar 530b), for example.

Note that an individual environmental sound created by subtracting the group 1 sound from the whole environmental sound for the cluster 3 is provided for the user who is located in the cluster 3 and who belongs to the group 1 (the user c of the avatar 530c).

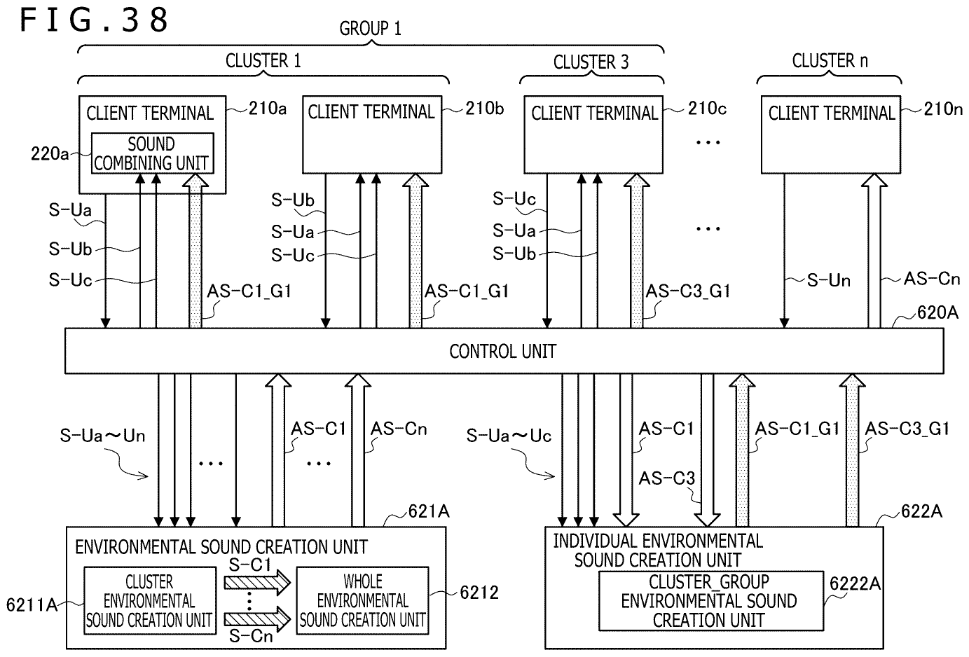

FIG. 38 is a diagram explaining details of creation of environmental sounds according to modification 1. Chiefly discussed herein will be data exchanged between a control unit 620A, an environmental sound creation unit 621A, and an individual environmental sound creation unit 622A of the server 60 according to modification 1.

As illustrated in FIG. 38, the control unit 620A first inputs, to the environmental sound creation unit 621A, the user sounds S-Ua to S-Un transmitted from the respective client terminals 210a to 210n, and performs control to cause the environmental sound creation unit 621A to create an environmental sound. The environmental sound creation unit 621A includes a cluster environmental sound creation unit 6211A which combines all sounds in a cluster to create a cluster environmental sound and a whole environmental sound creation unit 6212 which combines all cluster environmental sounds (S-C1 to S-Cn) to create an environmental sound of the whole virtual space.

The whole environmental sound creation unit 6212 carries out distance attenuation for each of the clusters in accordance with distances between clusters, and then combines the cluster environmental sounds of the respective clusters to create a whole environmental sound for each of the clusters (AS-C1 to AS-Cn). For example, for creating a whole environmental sound for the cluster 1 (C1), the whole environmental sound creation unit 6212 attenuates a cluster 2 environmental sound in accordance with the distance between the cluster 1 (C1) and the cluster 2 (C2), attenuates a cluster 3 environmental sound in accordance with the distance between the cluster 1 (C1) and the cluster 3 (C3), and repeats similar attenuation to complete attenuation up to a cluster 9 environmental sound attenuated in accordance with the distance between the cluster 1 (C1) and the cluster 9 (C9). The whole environmental sound creation unit 6212 then combines the cluster 1 environmental sound and the environmental sounds of the clusters 2 to 9 each obtained by distance attenuation.

Subsequently, in a case where the cluster environmental sounds used for creation of the whole environmental sounds (AS-C1 to AS-Cn) contain conversation voices in the group (specifically, voices of users belonging to the group), the control unit 620A inputs the whole environmental sounds of the clusters which contain avatars belonging to the group (AS-C1 and AS-C3 in the example illustrated in FIG. 38) and conversation voices in the group (user sounds S-Ua to S-Uc in the example illustrated in FIG. 38) to the individual environmental sound creation unit 622A. For performing this process, information indicating which user is emitting a sound contained in the cluster environmental sound may be added to the cluster environmental sound created for each of the clusters by the cluster environmental sound creation unit 6211A.

The individual environmental sound creation unit 622A includes a cluster_group environmental sound creation unit 6222A. The cluster_group environmental sound creation unit 6222A creates an individual environmental sound for users who are located in the cluster and who belong to the group, by subtracting a conversation voice in the group from a whole environmental sound of the corresponding cluster. For example, the cluster_group environmental sound creation unit 6222A creates an individual environmental sound AS-C1 G1 for users who are located in the cluster 1 and who belong to the group 1 and an individual environmental sound AS-C3 G1 for users who are located in the cluster 3 and who belong to the group 1.

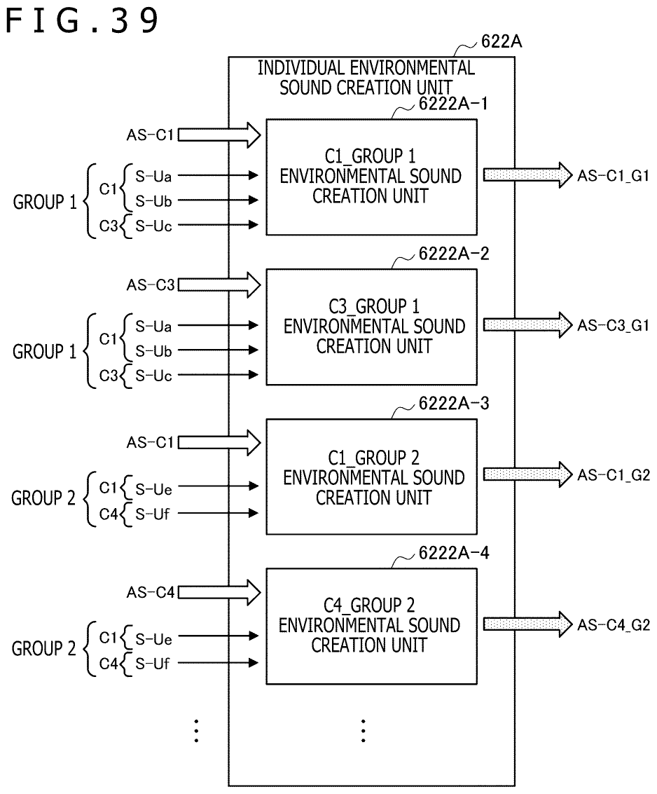

FIG. 39 is a diagram explaining creation of individual environmental sounds by the individual environmental sound creation unit 622A. The individual environmental sound creation unit 622A includes a Cn-group m environmental sound creation unit 6222A-o which creates an individual environmental sound for each cluster_group.

For example, for users who are located in the cluster 1 and who belong to the group 1, a C1_group 1 environmental sound creation unit 6222A-1 subtracts components of the user sounds S-Ua to S-Uc from the whole environmental sound AS-C1 on the basis of the whole environmental sound AS-C1 and the user sounds S-Ua to S-Uc corresponding to conversation voices of the group 1 to create and output a group 1 individual environmental sound AS-C1 G1 of the cluster 1.

Moreover, for users who are located in the cluster 3 and who belong to the group 1, for example, a C3 group 1 environmental sound creation unit 6222A-2 subtracts components of the user sounds S-Ua to S-Uc from the whole environmental sound AS-C3 on the basis of the whole environmental sound AS-C3 and the user sounds S-Ua to S-Uc corresponding to conversation voices of the group 1 to create and output a group 1 individual environmental sound AS-C3 G1 of the cluster 3.

The individual environmental sound creation unit 622A performs the above-described individual environmental sound creation process for each of the groups of the respective clusters.

Discussed herein again with reference to FIG. 38 will be the group 1 individual environmental sounds AS-C1 G1 of the cluster 1 and the group 1 individual environmental sound AS-C3 G1 of the cluster 3 both output from the individual environmental sound creation unit 622A. The control unit 620A transmits the group 1 individual environmental sounds AS-C1 G1 of the cluster 1 to each of the client terminals 210a and 210b which are included in the client terminals 210a to 210c constituting the group 1 and which correspond to the avatars 530a and 530b that are located in the cluster 1 and that belong to the group 1. Moreover, the control unit 620A transmits the group 1 individual environmental sounds AS-C3 G1 of the cluster 3 to the client terminal 210c corresponding to the avatar 530c that is located in the cluster 3 and that belongs to the group 1.

Further, the control unit 620A also transmits conversation voices of different users in the group 1 to the client terminals 210a to 210c. Specifically, the control unit 620A transmits the user sounds S-Ub and S-Uc to the client terminal 210a, transmits the user sounds S-Ua and S-Uc to the client terminal 210b, and transmits the user sounds S-Ua and S-Ub to the client terminal 210c.

Each of the client terminals 210 includes the sound combining unit 220. Sounds received via a different track are combined by the sound combining unit 220, and the resultant sound is provided for the users. For example, the sound combining unit 220a of the client terminal 210a combines the user sounds S-Ub and S-Uc and the group 1 individual environmental sound AS-C1 G1 of the cluster 1, and provides the resultant sound.

As described above, the group 1 individual environmental sound AS-C1 G1 of the cluster 1 is an environmental sound created by subtracting a conversation voice of the group 1 from the whole environmental sound AS-C1 of the cluster 1 as a sound created by combining cluster environmental sounds obtained by distance attenuation. In this case, a conversation voice of the group 1 is not heard as a double sound even when the group 1 individual environmental sound AS-C1 G1 and the conversation voice are combined and provided by the client terminal 210a. Accordingly, the user a of the client terminal 210a can clearly hear the conversation voice of the group 1 and also hear a real-time environmental sound in the virtual space, and can therefore enjoy a sense of realism. Moreover, because the whole environmental sound AS-C1 of the cluster 1 is created by combining cluster environmental sounds obtained by distance attenuation in accordance with distances between the clusters, a whole environmental sound variable for each place is providable, making it possible to further improve a sense of realism.

Note that the control unit 620A of the server 60 performs such control that a corresponding whole environmental sound AS-Cn of the cluster n is transmitted to the client terminal 210n which does not belong to the group.

### (Modification 2)

According to modification 1, the group m individual environmental sound AS-Cn Gm of the cluster n is created by subtracting a conversation voice of the group from the whole environmental sound AS-Cn of the cluster. However, creation of the group m individual environmental sound AS-Cn Gm of the cluster n in the present disclosure is not limited to this manner of creation. According to modification 2, the group m individual environmental sound AS-Cn Gm of the cluster n is created by creating a cluster environmental sound for a group from which a conversation voice in the group is removed, in parallel with creation of the cluster environmental sounds S-C1 to S-Cn, and using the created cluster environmental sound for the group.

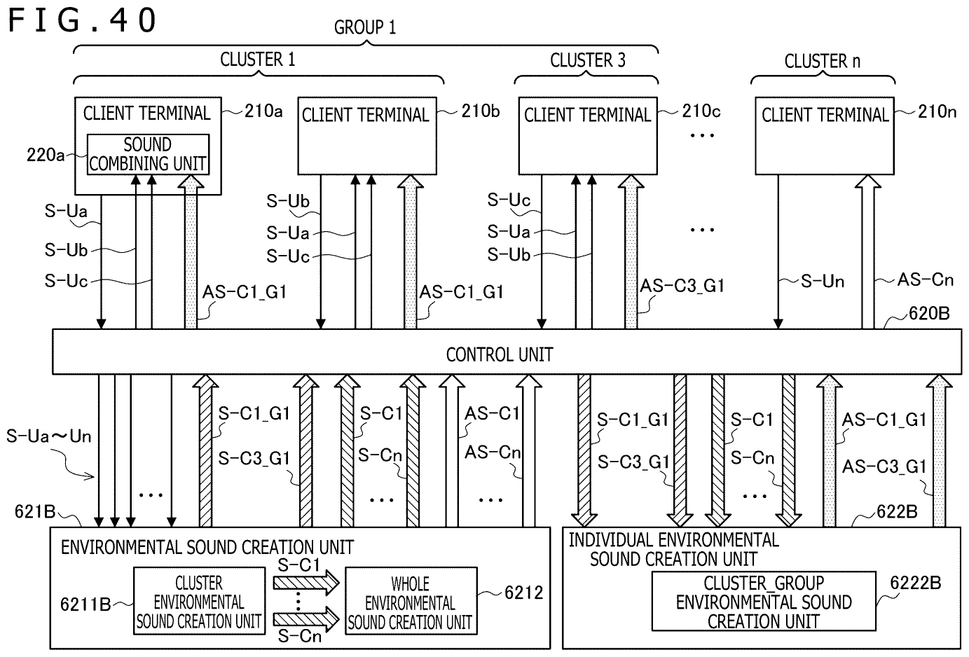

FIG. 40 is a diagram explaining details of creation of environmental sounds according to modification 2. Chiefly discussed herein will be data exchanged between a control unit 620B, an environmental sound creation unit 621B, and an individual environmental sound creation unit 622B of the server 60 according to modification 2.

As illustrated in FIG. 40, the control unit 620B first inputs, to the environmental sound creation unit 621B, the user sounds S-Ua to S-Un transmitted from the respective client terminals 210a to 210n, and performs control to cause the environmental sound creation unit 621B to create an environmental sound. The environmental sound creation unit 621B includes a cluster environmental sound creation unit 6211B which combines all sounds in the cluster to create a cluster environmental sound and the whole environmental sound creation unit 6212 which combines the cluster environmental sounds (S-C1 to S-Cn) to create an environmental sound of the whole virtual space. The whole environmental sound creation unit 6212 has a function similar to the corresponding function in modification 1 explained with reference to FIG. 38.

Unlike modification 1, the cluster environmental sound creation unit 6211B combines all sounds in the cluster to create a cluster environmental sound, and also creates a cluster environmental sound for the group from which a conversation voice in the group is removed. For example, assumed is a case where the avatars 530a and 530b belonging to the group 1 are located in the area of the cluster 1 (C1) in the virtual space V and where the avatar 530c belonging to the same group 1 is located in the area of the cluster 3 (C3). In this case, for the cluster 1, for example, the cluster environmental sound creation unit 6211B combines all sounds in the cluster 1 to create a cluster environmental sound S-C1, and also creates a group 1 cluster environmental sound S-C1 G1 of the cluster 1 by removing conversation voices of the users who belong to the group 1, i.e., the user sounds S-Ua and S-Ub of the user a and the user b corresponding to the avatars 530a and 530b, from all sounds in the cluster 1 and combining the resultant sounds. Also for the cluster 3, in a similar manner, the cluster environmental sound creation unit 6211B combines all sounds in the cluster 3 to create a cluster environmental sound S-C3, and also creates a group 1 cluster environmental sound S-C3 G1 of the cluster 3 by removing a conversation voice of the user who belongs to the group 1, i.e., the user sound S-Uc of the user c corresponding to the avatar 530c, from all sounds in the cluster 3 and combining the resultant sounds.

The cluster environmental sound creation unit 6211B outputs the cluster environmental sounds S-C1 to S-Cn to the whole environmental sound creation unit 6212. The whole environmental sound creation unit 6212 creates the whole environmental sound (AS-C1 to AS-Cn) for each cluster as in modification 1. The whole environmental sound creation unit 6212 has a function similar to the corresponding function in modification 1. Accordingly, detailed explanation is omitted herein.

Subsequently, the control unit 620B inputs, to the individual environmental sound creation unit 622B, the cluster environmental sounds S-C1 to S-Cn output from the cluster environmental sound creation unit 6211B, and the cluster environmental sound S-Cn Gm for the group (the group 1 cluster environmental sound S-C1 G1 of the cluster 1 and the group 1 cluster environmental sound S-C3 G1 of the cluster 3 in the example illustrated in FIG. 40), and performs control to cause the individual environmental sound creation unit 622B to create an individual environmental sound for users belonging to the group for each cluster.

The individual environmental sound creation unit 622B includes a cluster_group environmental sound creation unit 6222B. The cluster_group environmental sound creation unit 6222B creates an individual environmental sound for users belonging to the group for each cluster. For example, the cluster_group environmental sound creation unit 6222B creates the individual environmental sound AS-C1 G1 for users who are located in the cluster 1 and who belong to the group 1 and the individual environmental sound AS-C3 G1 for users who are located in the cluster 3 and who belong to the group 1. Note that the cluster_group environmental sound creation unit 6222B can combine cluster environmental sounds of respective clusters obtained by attenuation in accordance with distances between clusters, to create an individual environmental sound, as with the whole environmental sound creation unit 6212 in modification 1.

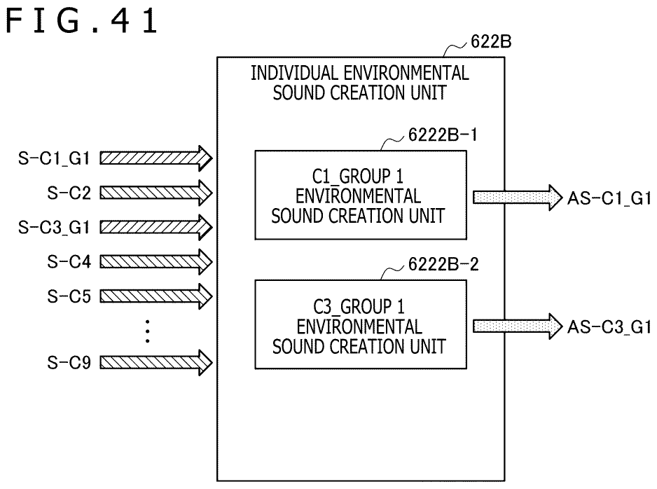

FIG. 41 is a diagram explaining creation of individual environmental sounds by the individual environmental sound creation unit 622B. The individual environmental sound creation unit 622B includes a Cn-group m environmental sound creation unit 6222B-o which creates an individual environmental sound for each cluster_group. The Cn-group m environmental sound creation unit 6222B-o combines cluster environmental sounds to create an individual environmental sound AS-Cn Gm.

For example, the C1_group 1 environmental sound creation unit 6222B-1 combines the group 1 cluster 1 environmental sound S-C1 G1 and the group 1 cluster 3 environmental sound S-C3 G1 from both of which a conversation voice in the group 1 is removed and cluster environmental sounds S-C2 and S-C4 to S-C9 of the other clusters (containing no user belonging to the group 1) to create the individual environmental sound AS-C1 G1 for the users who are located in the cluster 1 and who belong to the group 1. At this time, the C1_group 1 environmental sound creation unit 6222B-1 can combine the cluster environmental sounds obtained by attenuation in accordance with distances between clusters, to create an individual environmental sound.

Moreover, the C3 group 1 environmental sound creation unit 6222B-2 combines the group 1 cluster 1 environmental sound S-C1 G1 and the group 1 cluster 3 environmental sound S-C3 G1 from both of which a conversation voice in the group 1 is removed and the cluster environmental sound S-C2 and S-C4 to S-C9 of the other clusters (containing no user belonging to the group 1) to create the individual environmental sound AS-C3 G1 for the user who is located in the cluster 3 and who belongs to the group 3. At this time, the C3 group 1 environmental sound creation unit 6222B-2 can combine the cluster environmental sounds obtained by attenuation in accordance with distances between clusters, to create an individual environmental sound.

The individual environmental sound creation unit 622B performs the above-described individual environmental sound creation process for each of the groups of the respective clusters.

Discussed herein again with reference to FIG. 40 will be the group 1 individual environmental sounds AS-C1 G1 of the cluster 1 and the group 1 individual environmental sound AS-C3 G1 of the cluster 3 both output from the individual environmental sound creation unit 622B. The control unit 620B transmits the group 1 individual environmental sounds AS-C1 G1 of the cluster 1 to each of the client terminals 210a and 210b which are included in the client terminals 210a to 210c constituting the group 1 and which correspond to the avatars 530a and 530b that are located in the cluster 1 and that belong to the group 1. Moreover, the control unit 620B transmits the group 1 individual environmental sounds AS-C3 G1 of the cluster 3 to the client terminal 210c corresponding to the avatar 530c that is located in the cluster 3 and that belongs to the group 1.

Further, the control unit 620B also transmits conversation voices of different users in the group 1 to each of the client terminals 210a to 210c. Specifically, the control unit 620B transmits the user sounds S-Ub and S-Uc to the client terminal 210a, transmits the user sounds S-Ua and S-Uc to the client terminal 210b, and transmits the user sounds S-Ua and S-Ub to the client terminal 210c.

Each of the client terminals 210 includes the sound combining unit 220. Sounds received via a different track are combined by the sound combining unit 220, and the resultant sound is provided for the users. For example, the sound combining unit 220a of the client terminal 210a combines the user sounds S-Ub and S-Uc and the group 1 individual environmental sound AS-C1 G1 of the cluster 1, and provides the resultant sound.

The control unit 620B of the server 60 performs such control that the corresponding whole environmental sound AS-Cn of the cluster n is transmitted to the client terminal 210n which does not belong to the group.

According to modification 2 as described above, voice conversation in the group is removed at the time of creation of a cluster environmental sound. Thereafter, the individual environmental sound creation unit 622B creates an individual environmental sound by using a cluster environmental sound from which a voice conversation in the group has been removed beforehand.

### (Modification 3)

An environmental sound used in the embodiment and the modifications described above can appropriately be attenuated to such a level equivalent to noise of the whole virtual space. However, for providing a specific sound such as announcement and a voice of an artist in the virtual space, it is preferable that a sound which is more distinct than other environmental sounds be created in some cases.

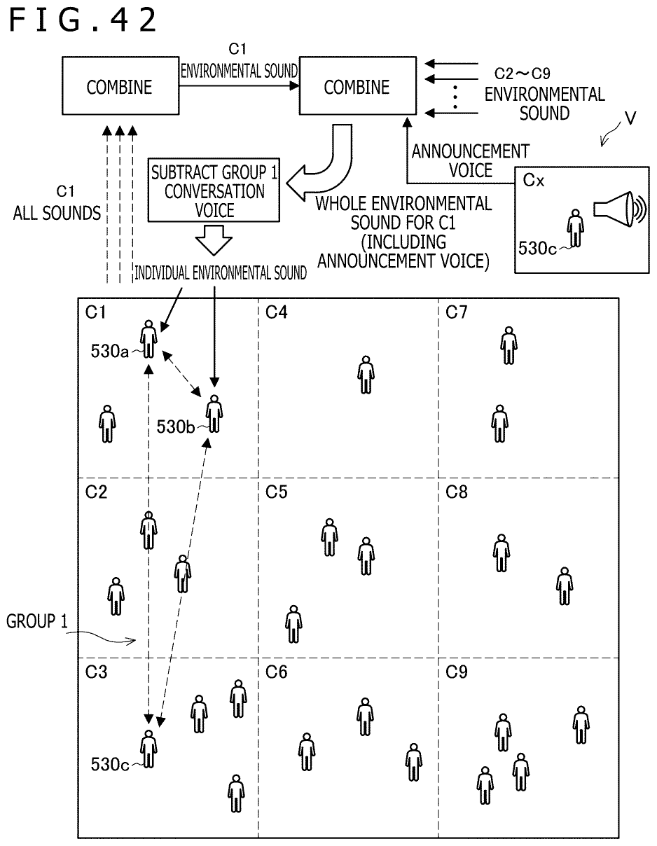

FIG. 42 is a diagram for explaining creation of an environmental sound according to modification 3. According to the example illustrated in FIG. 42, as in modification 1 explained with reference to FIG. 37, the virtual space V is divided into a plurality of areas, and all sounds in each cluster as a corresponding one of the divided areas are combined to create an environmental sound for the corresponding cluster. Thereafter, the cluster environmental sounds are combined into a whole environmental sound as an environmental sound of the whole virtual space.

The whole environmental sound is created for each cluster. At this time, the cluster environmental sounds used for creation of the whole environmental sound can be attenuated in accordance with distances between the clusters. Moreover, an environmental sound providing system according to modification 3 acquires, as a sound of a cluster Cx, a sound (announcement voice) from an avatar 530x operated by an authority such as a manager of the virtual space and an organizer of an event held in the virtual space, and combines the acquired sound with the cluster environmental sounds to create the whole environmental sound. In this case, the environmental sound providing system adjusts sounds such that a specific sound such as an announcement voice becomes more distinct than other environmental sounds (specifically, the cluster environmental sounds of the respective clusters) to create the whole environmental sound. For example, the environmental sound providing system may carry out gain adjustment to make an announcement voice more distinct than other environmental sounds. In addition, the environmental sound providing system may attenuate sounds other than an announcement voice to create the whole environmental sound. Further, the environmental sound providing system may adjust a sound volume or an EQ (equalizer) to make an announcement voice more distinct than other environmental sounds. In such a manner, the whole environmental sound in modification 3 can be created by sound adjustment performed in such a manner that a specific sound is more distinct than other environmental sounds. Accordingly, usability of the virtual space can be improved. For designating a specific sound, any sound may be selected and set by the user.

The environmental sound providing system may reduce the volume of the created whole environmental sound to a level causing no discomfort.

Note that an individual environmental sound can be provided for avatars constituting a group, as in modification 1. For example, the environmental sound providing system provides, for the user a and the user b corresponding to the avatars 530a and 530b that are located in the cluster 1 and that belong to the group 1, an individual environmental sound created by subtracting a conversation voice in the group 1 (specifically, voices of the user a, the user b, and the user c who belong to the group 1) from a whole environmental sound for the cluster 1 (after gain adjustment for making an announcement voice more distinct).

Moreover, the environmental sound providing system may perform a process for removing a predetermined annoying sound from a whole environmental sound as well as the process for creating a whole environmental sound containing a more distinct specific sound.

### (Modification 4)

According to the embodiment and the modifications described above, the whole environmental sound is created and provided as an environmental sound of the whole virtual space. However, the environmental sound of the whole virtual space created in the present disclosure is not limited to this type of sound, and may be a sound created in the following manner. Specifically, an environmental sound is created for each type, and any desired type of environmental sound is selected during sound combining by the sound combining unit 220 of the client terminal 210.

For example, the sound combining unit 220 of the client terminal 210 performs a process which does not use a predetermined type of environmental sound for combining or a process which reduces the volume of a predetermined type of environmental sound when combining this sound.

For example, the type of environmental sound includes a sound containing an announcement voice and a normal voice of participants and a sound for each area in the virtual space. For example, adaptable during a music festival held in the virtual space is such a process which enables only an environmental sound of a venue selected by the user with use of a selection UI (user interface) to be heard in environmental sounds created for each of venues. For example, the selection UI may be a list of names of venues or a venue map.

Discussed hereinafter as a specific example of modification 4 will be a system which creates and provides environmental sounds for each of venues in the virtual space.

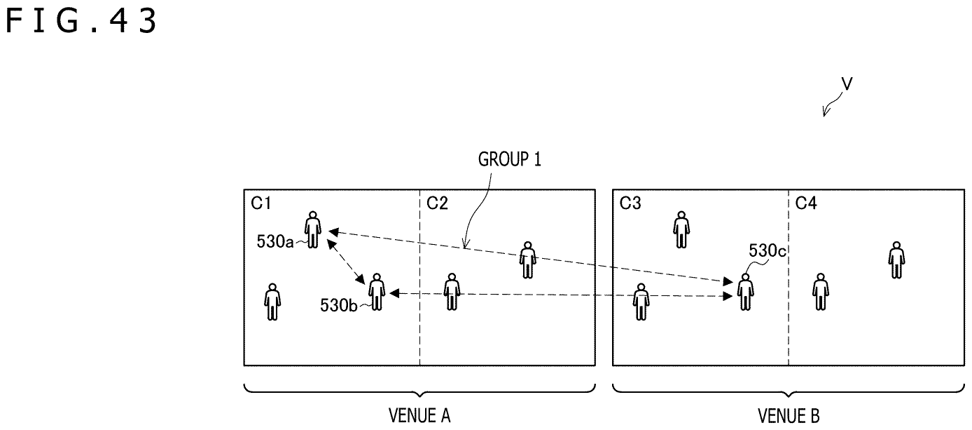

FIG. 43 is a diagram for explaining creation of environmental sounds according to modification 4. As illustrated in FIG. 43, assumed is a case where the virtual space V is divided into four clusters (small areas), and the four clusters are divided into two venues (large areas). A venue A includes a cluster 1 (C1) and a cluster 2 (C2), while a venue B includes a cluster 3 (C3) and a cluster 4 (C4).

Scaling out of the number of persons simultaneously connected to the virtual space can also be achieved by providing a system configuration which includes a transfer server (the SFU, for example) provided in each cluster and applying the technology explained in “1. Technology for scaling out number of persons simultaneously connected to metaverse virtual space.” In the environmental sound providing system according to modification 4, the server 60 and the client terminals 210 may transmit and receive data via the transfer servers. In the following description, use of the transfer servers is not specifically mentioned.

Moreover, as illustrated in FIG. 43, the avatars 530a and 530b located in the cluster C1 and the avatar 530c located in the cluster C3 constitute the group 1.

In such a situation, the environmental sound providing system according to modification 4 can create an environmental sound of the venue A and an environmental sound of the venue B, and provide the created sounds for the user. The user can select any type of environmental sound, i.e., turn on or off each of the environmental sounds of the venue A and the environmental sound of the venue B, by using the client terminal 210. Moreover, the user can adjust the volume as desired for each type of the environmental sounds.

In this manner, the user can hear sounds of both the venues A and B (environmental sounds of the venues) as desired from either one of the venues A and B in a case where a game, a talk, a musical performance, or the like is held in each of the venues A and B, for example. In a case where sounds are turned on for both of the venues while the user is present in the venue A, for example, the user can hear an environmental sound of the venue A and an environmental sound of the venue B. The venue B is a venue located next to the venue A. Accordingly, distance attenuation can be applied to the environmental sound of the venue B and provided in such a manner that the user in the venue A hears the sound from a distance. In a case where the user is curious about the situation of the venue B, such as a case where the user hears excited cheers in a direction from the venue B, the user can turn off the environmental sound of the venue A to carefully listen to the environmental sound of the venue B and then move to the venue B if interested in the event in the venue B, for example. In this manner, the user can further enjoy the virtual space.

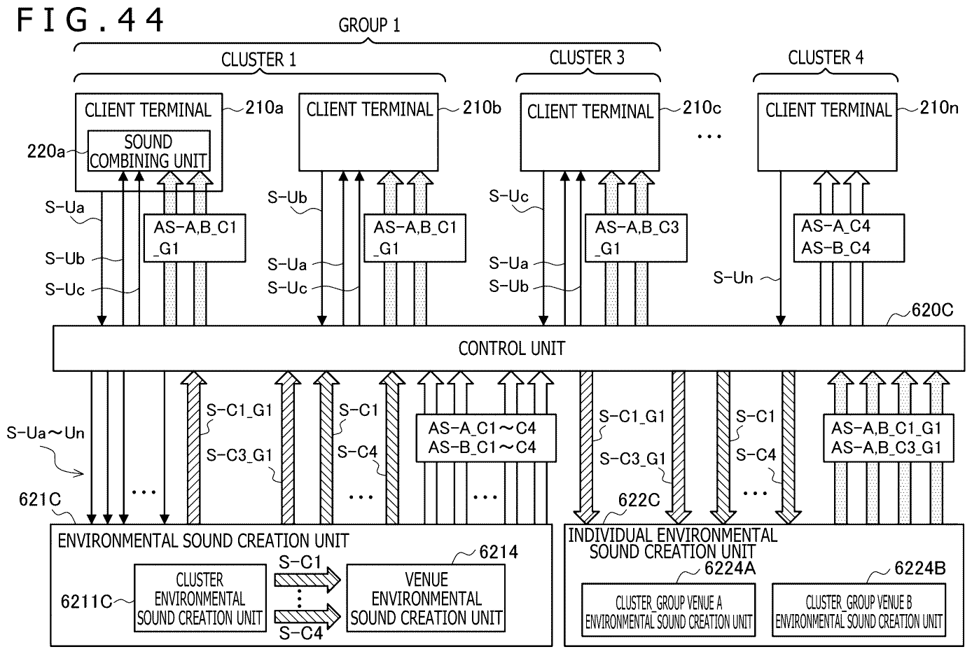

FIG. 44 is a diagram for explaining details of creation of environmental sounds according to modification 4. Chiefly discussed herein will be data exchanged between a control unit 620C, an environmental sound creation unit 621C for creating a venue environmental sound, and an individual environmental sound creation unit 622C for individually creating a venue environmental sound for the group, all included in the server 60 according to modification 4.

As illustrated in FIG. 44, the control unit 620C first inputs, to the environmental sound creation unit 621C, the user sounds S-Ua to S-Un transmitted from the respective client terminals 210a to 210n, and performs control to cause the environmental sound creation unit 621C to create a venue environmental sound. The environmental sound creation unit 621C includes a cluster environmental sound creation unit 6211C which combines all sounds in the cluster to create a cluster environmental sound and a venue environmental sound creation unit 6214 which appropriately combines the cluster environmental sounds (S-C1 to S-C4) to create a venue environmental sound.

As with the cluster environmental sound creation unit 6211B of modification 2, the cluster environmental sound creation unit 6211C combines all sounds in the cluster to create a cluster environmental sound, and also creates a cluster environmental sound for the group from which a conversation voice in the group is removed. Specifically, the cluster environmental sound creation unit 6211C creates cluster environmental sounds S-C1 to S-C4 for the respective clusters each produced by combining all sounds in the corresponding cluster, and also creates group cluster environmental sounds S-C1 G1 and S-C3 G1 from each of which a conversation voice in the group 1 (user sounds S-Ua to S-Uc) is removed.

The cluster environmental sound creation unit 6211C outputs the cluster environmental sounds S-C1 to S-C4 to the venue environmental sound creation unit 6214.

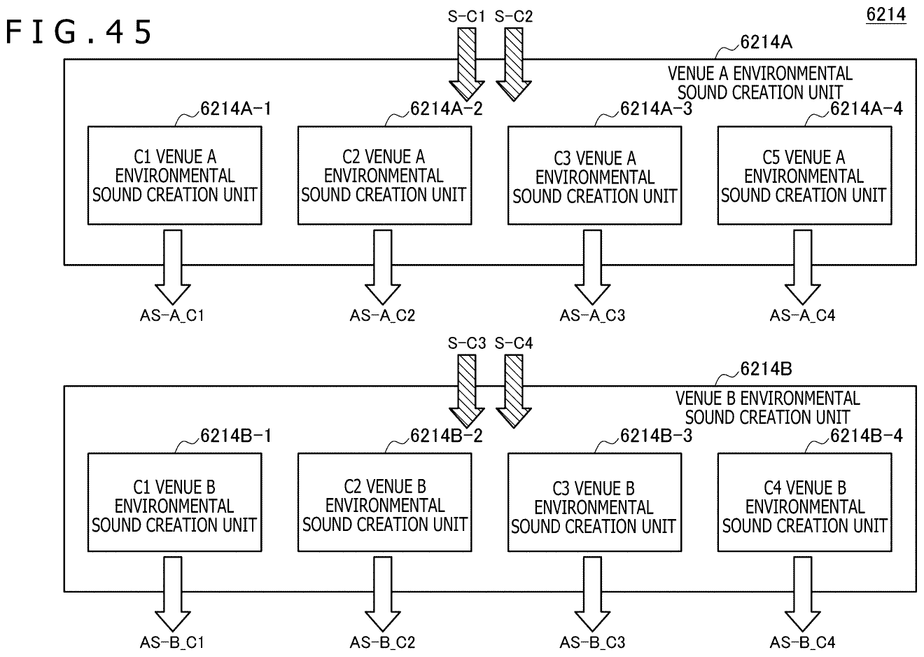

FIG. 45 is a diagram for explaining details of the venue environmental sound creation unit 6214. As illustrated in FIG. 45, the venue environmental sound creation unit 6214 includes a venue A environmental sound creation unit 6214A which creates an environmental sound of the venue A for each cluster and a venue B environmental sound creation unit 6214B which creates an environmental sound of the venue B for each cluster.

In this configuration, a sense of realism of the virtual space can be raised by controlling environmental sounds of the venue A and the venue B located next to each other, such that an environmental sound of the venue B is heard as more distant (fainter) sound than an environmental sound of the venue A in the cluster contained in the venue A and that an environmental sound of the venue A is heard as a more distant (fainter) sound than an environmental sound of the venue B in the cluster contained in the venue B. The venue environmental sound creation unit 6214 carries out appropriate distance attenuation for each cluster in accordance with positions of the respective clusters and positions of the venues to create environmental sounds of the respective venues for each cluster. Note that the position of each of the clusters may be set to a center position of the corresponding cluster (small area). In addition, the position of each of the venues may be set to a center position of the corresponding venue (large area).

As illustrated in FIG. 45, the venue A environmental sound creation unit 6214A creates venue A environmental sounds for the respective clusters (C1 to C4) on the basis of a cluster 1 environmental sound S-C1 and a cluster 2 environmental sound S-C2. Specifically, a C1 venue A environmental sound creation unit 6214A-1 creates a C1 venue A environmental sound AS-A C1, a C2 venue A environmental sound creation unit 6214A-2 creates a C2 venue A environmental sound AS-A C2, a C3 venue A environmental sound creation unit 6214A-3 creates a C3 venue A environmental sound AS-A C3, and a C4 venue A environmental sound creation unit 6214A-4 creates a C4 venue A environmental sound AS-A C4. Distance attenuation in accordance with distances between the clusters can be carried out for creation of the venue A environmental sound for each.

In addition, the venue B environmental sound creation unit 6214B creates venue B environmental sounds for the respective clusters (C1 to C4) on the basis of a cluster 3 environmental sound S-C3 and a cluster 4 environmental sound S-C4. Specifically, a C1 venue B environmental sound creation unit 6214B-1 creates a C1 venue B environmental sound AS-B C1, a C2 venue B environmental sound creation unit 6214B-2 creates a C2 venue B environmental sound AS-B C2, a C3 venue B environmental sound creation unit 6214B-3 creates a C3 venue B environmental sound AS-B C3, and a C4 venue B environmental sound creation unit 6214B-4 creates a C4 venue B environmental sound AS-B C4. Distance attenuation in accordance with distances between the clusters can be carried out for creation of the venue B environmental sound for each.

Subsequently, described with reference to FIG. 44 again, the control unit 620C inputs, to the individual environmental sound creation unit 622C, the cluster environmental sounds S-C1 to S-C4 output from the cluster environmental sound creation unit 6211C and the group cluster environmental sounds S-C1 G1 and S-C3 G1, and causes the individual environmental sound creation unit 622C to create an individual environmental sound for users belonging to the group for each cluster.

Specifically, the individual environmental sound creation unit 622C includes a cluster_group venue A environmental sound creation unit 6224A and a cluster_group venue B environmental sound creation unit 6224B, and creates an individual environmental sound of each venue (environmental sound from which a voice conversation of the group is removed) for each cluster_group.

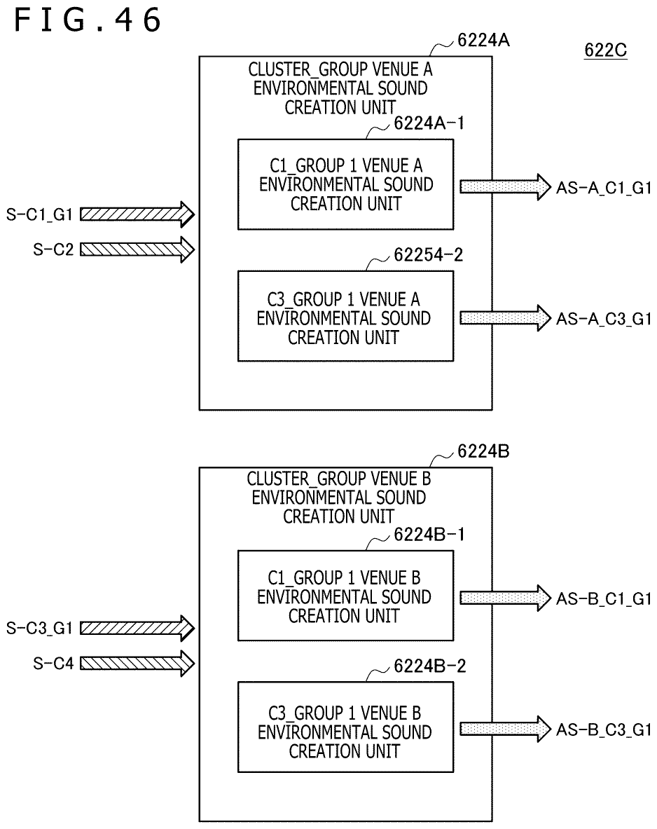

FIG. 46 is a diagram for explaining details of creation of individual environmental sounds by the individual environmental sound creation unit 622C. As illustrated in FIG. 46, for example, the cluster_group venue A environmental sound creation unit 6224A creates an individual environmental sound of the venue A for users who are located in the cluster 1 and who belong to the group 1 and an individual environmental sound of the venue A for users who are located in the cluster 3 and who belong to the group 1.

More specifically, a C1_group 1 venue A environmental sound creation unit 6224A-1 combines the cluster 2 environmental sound S-C2 and the group 1 cluster 1 environmental sound S-C1 G1 created by removing a conversation voice in the group 1, to create a venue A individual environmental sound AS-A C1 G1 for users who are located in the cluster 1 and who belong to the group 1. At this time, the C1_group 1 venue A environmental sound creation unit 6222A-1 combines the cluster environmental sounds obtained by attenuation in accordance with distances from the cluster 1.

In addition, a C3 group 1 venue A environmental sound creation unit 6224A-2 combines the cluster 2 environmental sound S-C2 and the group 1 cluster 1 environmental sound S-C1 G1 created by removing a conversation voice in the group 1, to create a venue A individual environmental sound AS-A C3 G1 for users who are located in the cluster 3 and who belong to the group 1. At this time, the C3 group 1 venue A environmental sound creation unit 6222A-2 combines the cluster environmental sounds obtained by attenuation in accordance with distances from the cluster 3.

Further, as illustrated in FIG. 46, the cluster_group venue B environmental sound creation unit 6224B creates an individual environmental sound of the venue B for users who are located in the cluster 1 and who belong to the group 1 and an individual environmental sound of the venue B for users who are located in the cluster 3 and who belong to the group 1, for example.

More specifically, a C1_group 1 venue B environmental sound creation unit 6224B-1 combines the cluster 4 environmental sound S-C4 and the group 1 cluster 3 environmental sound S-C3 G1 created by removing a conversation voice in the group 1, to create a venue B individual environmental sound AS-B C1 G1 for users who are located in the cluster 1 and who belong to the group 1. At this time, the C1_group 1 venue B environmental sound creation unit 6222B-1 combines cluster environmental sounds obtained by attenuation in accordance with distances from the cluster 1.

In addition, a C3 group 1 venue B environmental sound creation unit 6224B-2 combines the cluster 4 environmental sound S-C4 and the group 1 cluster 1 environmental sound S-C3 G1 created by removing a conversation voice in the group 1, to create a venue B individual environmental sound AS-B C3 G1 for users who are located in the cluster 3 and who belong to the group 1. At this time, the C3 group 1 venue B environmental sound creation unit 6222B-2 combines cluster environmental sounds obtained by attenuation in accordance with distances from the cluster 3.

The configuration described above can avoid such a situation where users belonging to the group hears a voice in the group as a double sound mixed with an environmental sound during voice conversation in the group.

Note that described in the present modification is the example of creation of an individual environmental sound with use of a cluster environmental sound for the group from which a conversation voice in the group has been removed beforehand, as in modification 2. However, the individual environmental sound for users belonging to the group according to the present disclosure is not limited to the sound created in this manner, and may be created with use of the technology of modification 1. Specifically, the environmental sound providing system according to the present modification may create the individual environmental sound for users belonging to the group by subtracting a conversation voice in the group from venue environmental sounds S-A, B Cn.

Discussed again with reference to FIG. 44 will be group 1 venue A, B individual environmental sounds AS-A, B C1 G1 of the cluster 1 and group 1 venue A, B individual environmental sounds AS-A, B C3 G1 of the cluster 3 both output from the individual environmental sound creation unit 622C. The control unit 620C transmits the group 1 venue A, B individual environmental sounds AS-A, B C1 G1 of the cluster 1 to each of the client terminals 210a and 210b which are included in the client terminals 210a to 210c constituting the group 1 and which correspond to the avatars 530a and 530b that are located in the cluster 1 and that belong to the group 1. Moreover, the control unit 620C transmits the group 1 venue A, B individual environmental sounds AS-A, B C3 G1 of the cluster 3 to the client terminal 210c corresponding to the avatar 530c that is located in the cluster 3 and that belongs to the group 1.

Further, the control unit 620C also transmits conversation voices of different users in the group 1 to each of the client terminals 210a to 210c. Specifically, the control unit 620C transmits the user sounds S-Ub and S-Uc to the client terminal 210a, transmits the user sounds S-Ua and S-Uc to the client terminal 210b, and transmits the user sounds S-Ua and S-Ub to the client terminal 210c.

Each of the client terminals 210 includes the sound combining unit 220. Sounds received via a different track are combined by the sound combining unit 220, and the resultant sound is provided for the users. For example, the sound combining unit 220a of the client terminal 210a combines the user sounds S-Ub and S-Uc and the group 1 venue A, B individual environmental sounds AS-A, B C1 G1 of the cluster 1, and provides the resultant sound. In this case, the sound combining unit 220a can select desired environmental sounds to be combined, in accordance with operations by the user. For example, the sound combining unit 220a may combine the user sounds S-Ub and S-Uc and the group 1 venue A, B individual environmental sounds AS-A, B C1 G1 of the cluster 1 and provide the resultant sound, combine the user sounds S-Ub and S-Uc and the group 1 venue A individual environmental sound AS-A C1 G1 of the cluster 1 and provide the resultant sound, or combine the user sounds S-Ub and S-Uc and the group 1 venue B individual environmental sound AS-B C1 G1 of the cluster 1 and provide the resultant sound.

As described above, the user is allowed to select a desired environmental sound for each type.

Accordingly, usability of the virtual space can be improved.

The control unit 620C of the server 60 performs such control that the venue A, B environmental sounds AS-A, B Cn of the corresponding cluster n (for example, venue A, B environmental sounds AS-A, B C4 of cluster 4) are transmitted to the client terminal 210n which does not belong to the group.

### <Supplementary Notes>

According to the modifications described above, it is described that the virtual space is divided into a plurality of areas as clusters, and sounds in each cluster are combined to create a cluster environmental sound. It is assumed that these clusters are statically set in the virtual space, such as areas formed by dividing the virtual space into equal parts beforehand. However, the clusters of the present disclosure are not limited to clusters set in this manner, and may dynamically be varied in the virtual space.

For example, the server 60 may set the areas of the clusters in accordance with positions of respective avatars that are active in the virtual space. Specifically, the server 60 may set the areas of the clusters on the basis of position information associated with avatars such that the number of the avatars is more equalized and less duplicated. In this case, a large number of clusters having small areas are set for a place containing a large number of avatars, while one cluster having a large area covers a place containing a small number of avatars. The server 60 can dynamically change the settings of the clusters as necessary in accordance with position changes of the respective avatars. In this manner, a processing load can be equalized for the clusters without an overwhelming load applied thereto. Accordingly, a larger number of avatars (users) can be handled.

Moreover, the server 60 may designate a group constituted by a plurality of users as a cluster. In this case, the server 60 can designate the center of gravity of the position of each avatar as the position of the cluster to perform the distance attenuation and the stereoscopic process described above. Each of the avatars is movable in the virtual space, and the position of the cluster can dynamically change in accordance with movement of the avatars. According to this configuration, a conversation voice in the group can be handled as one cluster environmental sound. In this case, users not belonging to the group can easily determine context of conversation held in the relevant group. Specifically, in a case where a cluster is set to an area, it is possible that a user not belonging to a group cannot hear one-side conversation given from a user who belongs to the group and who is located in a different area (cluster), due to distance attenuation. However, when a conversation voice in a group designated as a cluster is handled as one cluster environmental sound, such a problem that only one-side conversation can be heard due to distance attenuation is avoidable.

Note that the functions of the control unit 620 of the server 60 may be implemented by a plurality of servers. For example, the cluster environmental sound creation units 6211A and 6211B may create cluster environmental sounds by using servers (or virtual servers in a cloud) prepared for each cluster.

Moreover, the environmental sound providing system 3 according to the present embodiment may be implemented by the system configuration illustrated in FIG. 2 or 4. This system configuration includes the transfer servers (SFU: Selective Forwarding Unit, for example) provided in respective clusters each constituted by a plurality of the client terminals 210, and also includes the domain controller (server 60) provided as an information processing device in a layer higher than the transfer servers. The transfer servers and the domain controller can each include a server in a cloud service. Up to the 50 client terminals 210 may be connected to the one transfer server. In addition, up to 50 clusters may be provided in the network system.

Further, when the system configuration illustrated in FIG. 2 or 4 is adopted as the system configuration of the environmental sound providing system 3 of the present embodiment, “1. Technology for scaling out number of persons simultaneously connected to metaverse virtual space” may be applied. Specifically, pieces of data (streams) transmitted from the respective client terminals 210 to the transfer server (the SFU, for example) are combined into one stream by the transfer server. In a case where one cluster is constituted by 50 clients, 50 streams are combined into one stream, and transmitted from the transfer server to the domain controller. In this case, more traffic reduction is achievable than in a case where 50 streams transmitted from the respective client terminals 210 are transferred to the domain controller via the transfer server without change.

In addition, the environmental sound providing system 3 according to the present embodiment may be implemented by the system configuration illustrated in FIG. 19. In this case, the function of the server 60 can be implemented by the Domain Controllers 11 (11-1 to 11-3), for example.

In addition, the server 60 may be implemented by the hardware configuration illustrated in FIG. 20.

### 8. Additional Notes

While the preferred embodiments of the present disclosure have been described in detail with reference to the accompanying drawings, the present technology is not limited to these examples. It is apparent that various modified examples or corrected examples within the scope of the technical idea specified in the claims can be conceived of by those having ordinary knowledge in the technical field of the present disclosure. It should be understood that these modified examples or corrected examples obviously belong to the technical scope of the present disclosure.

For example, one or more computer programs for achieving the functions of the Domain Controller 11, the SFUs 103, the server 30, the server 60, or the client terminals 210 may be provided in hardware such as a CPU, a ROM, and a RAM each built in the Domain Controller 11, the SFUs 103, the server 30, the server 60, or the client terminals 210 described above. Moreover, a computer-readable storage medium which stores the one or more computer programs described above may also be provided.

Further, advantageous effects to be achieved are not limited to those described in the present disclosure only by way of explanation or example. Specifically, the technology according to the present disclosure can produce other advantageous effects obvious for those skilled in the art in the light of the description of the present disclosure together with or instead of the advantageous effects described above.

Note that the present technology can also be configured as follows.

(1)

A system including:
a control unit that controls client terminals used to operate avatars in a virtual space and controls information synchronization in a cluster containing a plurality of the client terminals, in which
a plurality of the clusters are present,
the control unit arranges virtual avatars in the virtual space,
the control unit creates sounds of the virtual avatars in accordance with a type of an event held in the virtual space, and
the control unit performs a stereoscopic process in accordance with positions of respective different avatars and the respective virtual avatars for sounds output from the client terminals and emitted from the different avatars and the virtual avatars.
   (2)

The system according to (1) above, in which
the control unit creates the sounds of the virtual avatars by using an inference model that has learned labelled sound data collected beforehand.
   (3)

The system according to (1) or (2) above, in which
the control unit transmits information transmitted from transfer servers provided in the respective clusters, each of the transfer servers combining pieces of information transmitted from the client terminals in the corresponding cluster and transferring the combined information to a different device as one stream information, to a different transfer server via a path different from a path used by the different transfer server for information transmission, and causes the information to be transmitted to the client terminals constituting the clusters managed by the respective transfer servers, and
the control unit further transmits sounds emitted from a plurality of the avatars and obtained from a first cluster including the plurality of avatars and sounds emitted from a plurality of virtual avatars and obtained from a second cluster including the plurality of virtual avatars, to the client terminals constituting a third cluster from the transfer server that manages the third cluster.
   (4)

The system according to any one of (1) to (3) above, in which
the control unit creates an environmental sound by combining sounds in the virtual space,
the control unit creates an individual environmental sound by removing sound components of the avatars from the environmental sound, and
the control unit outputs the individual environmental sounds from the client terminals corresponding to the avatars at a time of output of the environmental sounds from the client terminals.
   (5)

A system including:
a control unit that controls client terminals used to operate avatars in a virtual space and controls information synchronization in a cluster containing a plurality of the client terminals, in which
the control unit creates an environmental sound by combining sounds in the virtual space,
the control unit creates an individual environmental sound by removing sound components of the avatars from the environmental sound, and
the control unit outputs the individual environmental sounds from the client terminals corresponding to the avatars at a time of output of the environmental sounds from the client terminals.
   (6)

The system according to (5) above, in which
the control unit performs a process for attenuating the environmental sound.
   (7)

The system according to (5) or (6) above, in which
a plurality of the clusters are present,
the control unit creates a cluster environmental sound for each of the clusters, the cluster environmental sound being a sound obtained by combining sounds in the corresponding cluster,
the control unit creates a whole environmental sound by combining the cluster environmental sounds of the respective clusters,
the control unit creates an individual environmental sound by removing sound components of the avatars from the whole environmental sound, and
the control unit outputs the individual environmental sounds from the client terminals corresponding to the avatars at a time of output of the whole environmental sounds from the respective client terminals.
   (8)

The system according to (7) above, in which
the control unit acquires positions of the respective clusters, and at a time of creation of the whole environmental sound, the control unit performs distance attenuation in accordance with distances between the clusters or a stereoscopic process in accordance with a relative positional relation between the clusters and thereafter creates the whole environmental sound of each of the clusters.
   (9)

The system according to any one of (5) to (8) above, in which
the control unit performs a process for attenuating a sound other than a specific sound at a time of creation of the environmental sound.
   (10)

The system according to any one of (5) to (8) above, in which
the control unit performs gain adjustment that makes a specific sound more distinct than other sounds, at a time of creation of the environmental sound.
   (11)

The system according to (10) above, in which
the specific sound includes at least either an announcement voice in the virtual space or an artist voice in the virtual space.
   (12)

The system according to (11) above, in which
the specific sound is selectable by users who use the client terminals.
   (13)

The system according to any one of (7) to (12) above, in which
the control unit creates the whole environmental sound for each of venues each containing one or more of the clusters, and provides the created whole environmental sound for the client terminals.
   (14)

The system according to any one of (7) to (13) above, in which
the clusters correspond to a plurality of areas produced by dividing the virtual space, and
the control unit determines the cluster corresponding to the avatars in accordance with positions of the avatars.
   (15)

The system according to any one of (7) to (13) above, in which
each of the clusters corresponds to a group containing users corresponding to a plurality of the avatars.
   (16)

The system according to any one of (5) to (15) above, in which
the control unit provides, for a user who belongs to a group containing users corresponding to a plurality of the avatars, the individual environmental sound created by removing a conversation voice in the group from the environmental sound.
   (17)

The system according to (5) above, in which
a plurality of the clusters are present,
transfer servers are provided in the respective clusters, each of the transfer servers transferring, to a different device, information transmitted from the client terminals in the corresponding cluster,
each of the transfer servers combines pieces of information transmitted from the client terminals constituting the corresponding cluster and transmits the combined information as one stream information,
the control unit transmits the information transmitted from each of the transfer servers, to a different transfer server via a path different from a path used by the different transfer server for information transmission, and causes the information to be transmitted to the client terminals constituting the clusters managed by the respective transfer servers, and
the one stream information includes the environmental sound.
   (18)

A method performed by a processor, including:
controlling client terminals used to operate avatars in a virtual space and controlling information synchronization in a cluster containing a plurality of the client terminals;
creating an environmental sound by combining sounds in the virtual space;
creating an individual environmental sound by removing sound components of the avatars from the environmental sound; and
outputting the individual environmental sounds from the client terminals corresponding to the avatars at a time of output of the environmental sounds from the client terminals.
   (19)

A program causing a computer to function as:
a control unit that controls client terminals used to operate avatars in a virtual space and controls information synchronization in a cluster containing a plurality of the client terminals, in which
the control unit creates an environmental sound by combining sounds in the virtual space,
the control unit creates an individual environmental sound by removing sound components of the avatars from the environmental sound, and
the control unit outputs the individual environmental sounds from the client terminals corresponding to the avatars at a time of output of the environmental sounds from the client terminals.

### REFERENCE SIGNS LIST

1: Network system
11: Domain Controller
12: Scene Constructor
13: Interaction Inferencer
21: Session Manager
22: Cluster Manager
101: Browser
102: Native App
103-1 to 103-4: SFU
104: Crowd Simulator
111: HTTP Server
112: Domain Attribute Applier
113: Data Mixer
2: Volume control system
3: Environmental sound providing system
210, 212: Client terminal
220: Sound combining unit
230: Individual environmental sound creation unit
30: Server
310: Communication unit
320: Control unit
321: Position information acquisition unit
322: Position change prediction unit
323: Volume adjustment unit
330: Storage unit
331: History DB
40, 42: Network
60: Server
610: Communication unit
620, 620A, 620B, 620C: Control unit
621, 621A, 621B, 621C: Environmental sound creation unit
6211A, 6211B, 6211C: Cluster environmental sound creation unit
6212: Whole environmental sound creation unit
6214: Venue environmental sound creation unit
622, 622A, 622B, 622C: Individual environmental sound creation unit
6221: Group environmental sound creation unit
6221-1: Group 1 environmental sound creation unit
6221-2: Group 2 environmental sound creation unit
6222A, 6222B: Cluster_group environmental sound creation unit
6224A: Cluster_group venue A environmental sound creation unit
6224B: Cluster_group venue B environmental sound creation unit
630: Storage unit
631: Group DB
500, 530: Avatar

1. A system comprising:
a control unit that controls client terminals used to operate avatars in a virtual space and controls information synchronization in a cluster containing a plurality of the client terminals, wherein
a plurality of the clusters are present,
the control unit arranges virtual avatars in the virtual space,
the control unit creates sounds of the virtual avatars in accordance with a type of an event held in the virtual space, and
the control unit performs a stereoscopic process in accordance with positions of respective different avatars and the respective virtual avatars for sounds output from the client terminals and emitted from the different avatars and the virtual avatars.

2. The system according to claim 1, wherein
the control unit creates the sounds of the virtual avatars by using an inference model that has learned labelled sound data collected beforehand.

3. The system according to claim 1, wherein
the control unit transmits information transmitted from transfer servers provided in the respective clusters, each of the transfer servers combining pieces of information transmitted from the client terminals in the corresponding cluster and transferring the combined information to a different device as one stream information, to a different transfer server via a path different from a path used by the different transfer server for information transmission, and causes the information to be transmitted to the client terminals constituting the clusters managed by the respective transfer servers, and
the control unit further transmits sounds emitted from a plurality of the avatars and obtained from a first cluster including the plurality of avatars and sounds emitted from a plurality of virtual avatars and obtained from a second cluster including the plurality of virtual avatars, to the client terminals constituting a third cluster from the transfer server that manages the third cluster.

4. The system according to claim 1, wherein
the control unit creates an environmental sound by combining sounds in the virtual space,
the control unit creates an individual environmental sound by removing sound components of the avatars from the environmental sound, and
the control unit outputs the individual environmental sounds from the client terminals corresponding to the avatars at a time of output of the environmental sounds from the client terminals.

5. A system comprising:
a control unit that controls client terminals used to operate avatars in a virtual space and controls information synchronization in a cluster containing a plurality of the client terminals, wherein
the control unit creates an environmental sound by combining sounds in the virtual space,
the control unit creates an individual environmental sound by removing sound components of the avatars from the environmental sound, and
the control unit outputs the individual environmental sounds from the client terminals corresponding to the avatars at a time of output of the environmental sounds from the client terminals.

6. The system according to claim 5, wherein
the control unit performs a process for attenuating the environmental sound.

7. The system according to claim 5, wherein
a plurality of the clusters are present,
the control unit creates a cluster environmental sound for each of the clusters, the cluster environmental sound being a sound obtained by combining sounds in the corresponding cluster,
the control unit creates a whole environmental sound by combining the cluster environmental sounds of the respective clusters,
the control unit creates an individual environmental sound by removing sound components of the avatars from the whole environmental sound, and
the control unit outputs the individual environmental sounds from the client terminals corresponding to the avatars at a time of output of the whole environmental sounds from the respective client terminals.

8. The system according to claim 7, wherein
the control unit acquires positions of the respective clusters, and at a time of creation of the whole environmental sound, the control unit performs distance attenuation in accordance with distances between the clusters or a stereoscopic process in accordance with a relative positional relation between the clusters and thereafter creates the whole environmental sound of each of the clusters.

9. The system according to claim 5, wherein
the control unit performs a process for attenuating a sound other than a specific sound at a time of creation of the environmental sound.

10. The system according to claim 5, wherein
the control unit performs gain adjustment that makes a specific sound more distinct than other sounds, at a time of creation of the environmental sound.

11. The system according to claim 10, wherein
the specific sound includes at least either an announcement voice in the virtual space or an artist voice in the virtual space.

12. The system according to claim 11, wherein
the specific sound is selectable by users who use the client terminals.

13. The system according to claim 7, wherein
the control unit creates the whole environmental sound for each of venues each containing one or more of the clusters, and provides the created whole environmental sound for the client terminals.

14. The system according to claim 7, wherein
the clusters correspond to a plurality of areas produced by dividing the virtual space, and
the control unit determines the cluster corresponding to the avatars in accordance with positions of the avatars.

15. The system according to claim 7, wherein
each of the clusters corresponds to a group containing users corresponding to a plurality of the avatars.

16. The system according to claim 5, wherein
the control unit provides, for a user who belongs to a group containing users corresponding to a plurality of the avatars, the individual environmental sound created by removing a conversation voice in the group from the environmental sound.

17. The system according to claim 5, wherein
a plurality of the clusters are present,
transfer servers are provided in the respective clusters, each of the transfer servers transferring, to a different device, information transmitted from the client terminals in the corresponding cluster,
each of the transfer servers combines pieces of information transmitted from the client terminals constituting the corresponding cluster and transmits the combined information as one stream information,
the control unit transmits the information transmitted from each of the transfer servers, to a different transfer server via a path different from a path used by the different transfer server for information transmission, and causes the information to be transmitted to the client terminals constituting the clusters managed by the respective transfer servers, and
the one stream information includes the environmental sound.

18. A method performed by a processor, comprising:
controlling client terminals used to operate avatars in a virtual space and controlling information synchronization in a cluster containing a plurality of the client terminals;
creating an environmental sound by combining sounds in the virtual space;
creating an individual environmental sound by removing sound components of the avatars from the environmental sound; and
outputting the individual environmental sounds from the client terminals corresponding to the avatars at a time of output of the environmental sounds from the client terminals.

19. A program causing a computer to function as:
a control unit that controls client terminals used to operate avatars in a virtual space and controls information synchronization in a cluster containing a plurality of the client terminals, wherein
the control unit creates an environmental sound by combining sounds in the virtual space,
the control unit creates an individual environmental sound by removing sound components of the avatars from the environmental sound, and
the control unit outputs the individual environmental sounds from the client terminals corresponding to the avatars at a time of output of the environmental sounds from the client terminals.
